(19) United States
(12) Patent Application Publication
(10) Pub. No.: US 2015/0371189 A1
(43) Pub. Date: Dec. 24, 2015

(54) Method and system for enabling the creation, development, and fulfillment of products and services by crowdsourcing relevant customers, producers, and investors

(71) Applicants: Gregor Z. Hanuschak, Ocean View, DE (US); Regaip A. Sen, San Francisco, CA (US)

(72) Inventors: Gregor Z. Hanuschak, Ocean View, DE (US); Regaip A. Sen, San Francisco, CA (US)

(21) Appl. No.: 14/741,397

(22) Filed: Jun. 16, 2015

Related U.S. Application Data
(60) Provisional application No. 62/014,646, filed on Jun. 19, 2014.

(51) Int. Cl. G06Q 10/10; G06Q 20/10; G06Q 20/28; G06Q 30/02

(52) U.S. Cl. CPC G06Q 10/101; G06Q 30/0202; G06Q 20/10; G06Q 30/0206; G06Q 20/28

(57) ABSTRACT

The present invention provides a method and system for creating new products and services, aggregating demand for said products and services, and introducing said products and services into the marketplace. The invention provides a means for: 1.) consumers to specify products and services that they desire, 2.) consumers to make known their intention to purchase said products and services, and 3.) sellers to find and develop the products and services which have aggregated significant consumer demand.

The present invention uses crowdsourcing to accomplish its goals. It crowdsources idea generation, demand aggregation, and vendors, and does so in a way that 1.) effectively solicits ideas from any innovator, 2.) gathers feedback from the crowd, and 3.) utilizes a competitive free market mentality to drive results.

The present invention can also be used for policy changes and infrastructural projects due to the invention's versatility.

### CROSS REFERENCE TO RELATED APPLICATIONS

This application claims priority to U.S. provisional application No. 62/014,646 entitled “METHOD AND SYSTEM FOR ENABLING THE CREATION, DEVELOPMENT, AND FULFILLMENT OF PRODUCTS AND SERVICES BY CROWDFUNDING RELEVANT CUSTOMERS, PRODUCERS, AND INVESTORS”, filed on Jun. 19, 2014, the contents of such application being incorporated by reference herein.

### FIELD OF THE INVENTION

The present invention relates to the fields of crowdsourcing, crowdfunding, online commerce, new product/service development, and demand aggregation.

### BACKGROUND OF THE INVENTION

A need exists for a “one-stop-shop” that not only accepts new product/service ideas from any entity, but also provides a means to further develop those ideas and even bring the best of those ideas to reality. There are websites (also known as “sites”) that attempt to do parts of this: they crowdsource ideas, aggregate demand, and/or aid in the discovery of vendors which can provide or even produce a given product. However, no site currently exists that concurrently crowdsources in all three of these areas and does so in a way which 1.) effectively solicits ideas from any innovator, 2.) gathers feedback from the crowd, and 3.) utilizes a competitive free market mentality to drive results.

### SUMMARY OF THE INVENTION

In accordance with an aspect of the present invention, there is provided a method for simplifying product idea development. At minimum, the method includes steps of first receiving, by a server computer system via a web application running on a first client computer system, a product idea, and then receiving, by the same server computer system via the web application running on a plurality of second client computer systems, feedback on the product idea from potential customers. This feedback can include binding offers to pay for the product if the feedback is followed. The method further includes steps of calculating, by the server computer system, demand metrics based on the feedback received and transmitting, by the server computer system via the web application running on the first client computer system, these demand metrics for the user of the first client computer system. Since offers to pay for the product are only binding if the feedback attached to that offer is followed, the demand metrics can help the user to determine what product features should be provided to make the most money.

The method can also include steps of transmitting, by the server computer system via the web application running on a plurality of third client computer systems, the same demand metrics to users who can potentially provide the product for those that want to see it come to fruition. If a user of a third client computer system thinks there is enough money involved and that he (or his team or his company) can potentially develop, source, create, execute, and/or deliver the product, he may wish to send a proposal to the user of the first client computer system offering his services. The method can include further steps of receiving, by the server computer system via the web application running on third client computer systems, proposals to provide the product for those who offered to pay for it and transmitting, by the server computer system via the web application running on the first client computer system, these proposals to the user of the first client computer system. After the user of the first client computer system makes a decision about which user (or users) of the third client computer systems should develop, source, create, execute, and/or deliver the product, the method includes steps of receiving, by the server computer system via a web application running on a first client computer system, selection messages, and then transmitting, by the server computer system via the web application running on the third client computer systems, these selection messages. Each selection message grants permission for a selected user of a third client computer system to have the right to a percentage of the money from the binding offers to pay for the product and the right and requirement to provide the product for those with binding offers to pay provided that the selected user will follow the feedback attached to those binding offers as per the information contained in the selected user's proposal.

In accordance with another aspect of the present invention, there is provided a system for simplifying product idea development. At minimum, this system includes a server computer system, a first client computer system, and a plurality of second client computer systems. The first client computer system is configured for receiving product ideas and transmitting them to a server computer system using a web application running on the first client computer system. The plurality of second client computer systems then uses the web application to receive feedback on the product idea from potential customers including binding offers to pay for the product if the feedback is followed. This information is also transmitted to the server computer system using the web application. The server computer system then uses the received information to calculate demand metrics and transmits these metrics to the user of the first client computer system via the web application running on the first client computer system. Again, since offers to pay for the product are only binding if the feedback attached to that offer is followed, the demand metrics can help the user determine what product features should be provided in order to make the most money.

The system can also include a plurality of third client computer systems. The server computer system can be further configured to transmit demand metrics to any of these third client computer systems via the web application running on these third client computer systems. If a user of a third client computer system thinks there is enough money involved and that he (or his team or his company) can potentially develop, source, create, execute, and/or deliver the product, he may wish to send a proposal to the user of the first client computer system offering his services. The system can be further configured to receive, via the web application running on the third client computer systems, proposals to provide the product and transmit the proposals to the first client computer system by way of the server computer system and the web application running on the first client computer system. After the user of the first client computer system makes a decision about which user (or users) of the third client computer systems should develop, source, create, execute, and/or deliver the product, the user may wish to send one or more selection messages. The system can be further configured to receive, via the web application running on the first client computer system, the selection messages and transit the selection messages to third client computer systems by way of the server computer system and the web application running on the third client computer systems. Once again, each selection message grants permission for a selected user of a third client computer system to have the right to a percentage of the money from the binding offers to pay for the product and the right and requirement to provide the product for those with binding offers to pay provided that the selected user will follow the feedback attached to those binding offers as per the information contained in the selected user's proposal.

### BRIEF DESCRIPTION OF THE DRAWINGS

FIG. 1 illustrates an overview of a method for simplifying product idea development, in accordance with an exemplary embodiment of the present invention;

FIGS. 2, 2A, and 2B illustrate a method for approval of multiple makers (at successively lower price points), in accordance with an exemplary embodiment of the present invention;

FIGS. 3, 3A, and 3B illustrate a method for approval of multiple makers (no restrictions on maker price points), in accordance with an exemplary embodiment of the present invention;

FIG. 4 illustrates a method of bid gathering and specification refinement, in accordance with an exemplary embodiment of the present invention;

FIG. 5 illustrates a method for maintaining an originator role of a product idea, in accordance with an exemplary embodiment of the present invention;

FIG. 6 illustrates a method of maker development, in accordance with an exemplary embodiment of the present invention;

FIG. 7 illustrates a method for transferring a prototype or presentation, in accordance with an exemplary embodiment of the present invention;

FIG. 8 illustrates a method for transferring intellectual property for ideas that are patentable or already patented, in accordance with an exemplary embodiment of the present invention;

FIG. 9 illustrates a transaction processes, in accordance with an exemplary embodiment of the present invention;

FIG. 10 illustrates markets covered by conventional crowdfunding sites, in accordance with an exemplary embodiment of the present invention;

FIG. 11 illustrates markets covered by conventional freelance sites, in accordance with an exemplary embodiment of the present invention;

FIG. 12 illustrates the markets covered by an exemplary embodiment of the present invention, in accordance with an exemplary embodiment of the present invention; and

FIG. 13 illustrates a system for performing the methods of FIGS. 1 through 9, in accordance with an exemplary embodiment of the present invention.

### DETAILED DESCRIPTION OF THE INVENTION

Detailed descriptions depicting exemplary embodiments of the present invention are provided herein. It is to be understood, however, that the present invention may be embodied in additional forms. Therefore, specific details disclosed herein are not to be interpreted as limiting, but rather as a basis for the claims and as a representative basis for teaching one skilled in the art to employ the present invention in virtually any appropriately detailed system, structure, or manner.

In traditional online commerce, consumers interact with a maker's site or a third-party marketplace to buy products which already exist or have already been defined. However, there are many consumer needs and desires which are not currently addressed in the marketplace and are not well communicated to product providers. These same product providers are often looking for innovation, even spending considerable sums of money and effort on surveys and marketing studies to figure out what products they should produce, develop, and/or offer next.

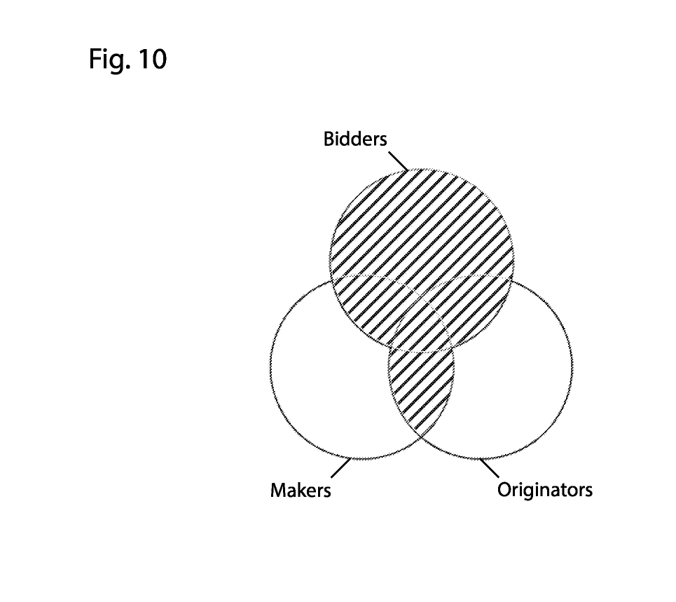

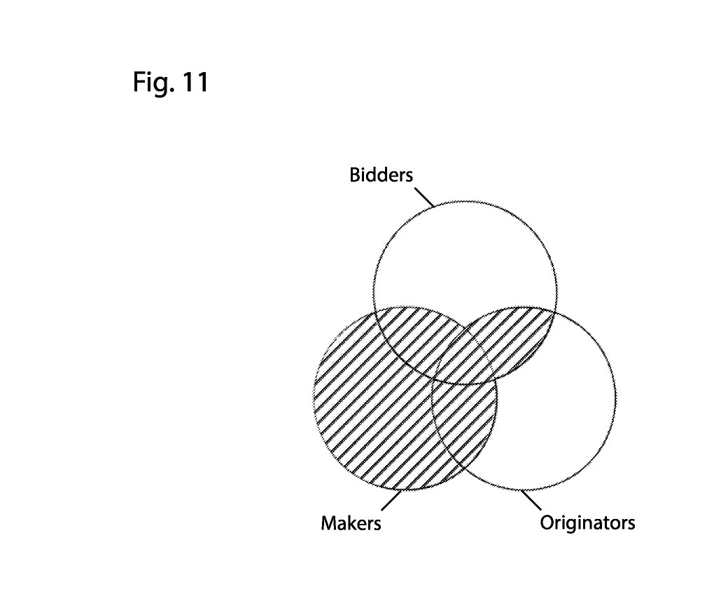

Crowdfunding sites exist which attempt to address these unrealized consumer needs and desires. Kickstarter.com is one such site. Such sites do provide the opportunity for new product ideas to enter the marketplace and the opportunity for other consumers to express their interest in these ideas. However, despite the positive ramifications of these sites, the majority have fundamental limitations. First, the sites focus on crowdsourcing ideas from individuals that already have something to develop and sell, know how to develop it further, and only need money from potential customers and investors to finish the project. In essence, the originators, those providing the product ideas on Kickstarter.com must also have the ability to become makers (see the hatched area of FIG. 10 for a representation of the market that is covered by such sites). Such originator/makers are not the only ones with ideas however. Innovation can come from anywhere (represented by circle labeled “Originators” in FIG. 11), even those who do not possess the knowledge or ability to develop the ideas on their own. The majority of crowdfunding sites fail to provide a mechanism to accept ideas from the masses.

The second limitation of crowdfunding sites like Kickstarter is that they do not provide a good means to gather feedback from potential customers. For sites like these, an originator/maker must already have a prototype in order to post his idea and the only feedback the originator/maker receives is whether or not people are willing to buy the product proposed by that prototype. Often times however, many more customers might have been willing to buy a proposed product on Kickstarter if it had been proposed with slight feature variations. In these cases, it would have been helpful if the originator/maker had known about the desired feature variations before creating the prototype.

To get feedback before posting to crowdfunding sites, people often use sites like SurveyMonkey.com to get feedback about a product idea using surveys. These sites also have limitations however. First, those that take surveys are not necessarily invested enough in the product idea to ever buy the product. It would be much better to design a prototype based on feedback from those that would actually buy the resulting product proposed by the prototype. Second, by getting feedback from a different site rather than the one used to get potential customers, an originator/maker is even less likely to be incorporating feedback into his prototype from those who would buy the product since there is no guarantee those who gave feedback on one site are users that also frequent the second site.

In contrast, the present invention offers embodiments which allow more originators (including originator/makers) to post ideas. These originators (including the originator/makers) can gather feedback earlier in the product development life cycle than they can on traditional crowdfunding sites. (Note that products, services, policy changes, and infrastructural projects will often be collectively referred to as “products” in this document.) In such an embodiment of the present invention, the originator is not required to produce a prototype in order to post his idea using the web application and therefore, the product idea can be more fully defined by feedback before time is spent creating such a prototype. In addition, the embodiment can allow originators (including originator/makers) to solicit the same audience to gather feedback as it does to gather potential customers since the web application is a single web application with a single audience. Furthermore, the web application seeks out only the members of that audience willing to pay for a product idea when gathering feedback and ensures a user's willingness to pay by actually collecting payment information. In doing so, the web application gathers meaningful feedback about the features that customers really are willing to pay for.

Sites also exist which can connect an originator to freelancer makers who can develop the originator's ideas. Some examples of these are oDesk.com, Elance.com, and freelancer.com. These sites crowdsource makers, but only focus on crowdsourcing ideas from originators with the financial means to pay a maker (see the hatched area of FIG. 11 for a representation of the market that is covered by such sites). Again, innovation can come from anywhere (represented by circle labeled “Originators” in FIG. 11) not just originator/bidders. In contrast, the present invention offers embodiments that do not place a financial restriction on originators since it collects money from customers in order to gather enough money to pay potential makers to develop, source, create, execute, and/or deliver the product idea.

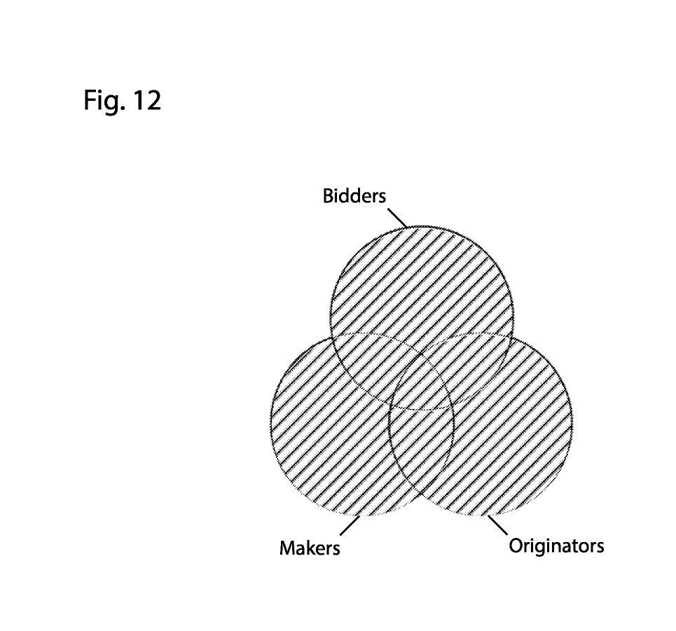

Exemplary embodiments of the present invention provide a new way to crowdsource innovation, funding, and production of new ideas. They do so in a way which allows those who wish to contribute to the process of new product development the opportunity to focus on the area or areas they are best at: innovating new ideas, recognizing good ideas, fleshing out ideas into product requirements, and/or using requirements to develop the final product (see FIG. 12 for a visual representation of the stakeholders which can participate in new product development using embodiments of the present invention). Although users can still participate in more than one area if they wish, there is no requirement for them to do so.

Using exemplary embodiments of the methods described herein, pure originators (originators that are neither originator/makers nor originator/bidders) can focus on what they do best: generating good ideas. Originators don't need to know how to make their ideas happen, nor do they require the financial means to hire someone to figure it out. They don't even need to know how to flesh out the requirements to create the necessary details since initial idea descriptions can be as simple as a single sentence.

Exemplary embodiments of the present invention crowdsource innovation from originators. Through the exemplary methods 100, 200, and 300 described herein, this crowdsourcing of innovation is accomplished through an interactive web application. Using the web application, an originator can publicly declare an idea for a product along with a declared price they would pay for that product. Once an idea/price declaration is available in a public setting, other individuals or entities, each with their own set of specialized skills, contribute to the next steps of product realization.

“Bidders” are those who know how to recognize good ideas, and using the disclosed method, they can focus on what they do best. Bidders can browse ideas from originators and even make suggestions on how to improve an idea to make it better. Bidders that really like where an idea is headed can pre-order the product for delivery when an appropriate supplier has been found. In systems 100, 200, and 300, the price a bidder declares he is willing to pay to pre-order a product need not be correlated to the price declared by the originator. Instead, a bidder declares the maximum price he personally is willing to pay for a product which may be higher or lower than what the originator is willing to pay. In the area of funding new ideas, the present invention crowdsources from bidders. All bidder price points are retained as demand aggregation data and, without revealing the bidder identities for specific price points, the data can be made publicly available.

“Makers” are developers, producers, and vendors. They are the ones that receive money from originators and bidders in exchange for supplying desired products.

Both corporations and individuals can serve the role of makers. Without limitation, makers can include artisans, engineers, and those skilled in product design. Makers can even be owners/operators of specialized machinery such as mills, lathes, 3D printers, and plastic injection molding machines. Using the disclosed method, makers can focus on what they do best: developing a product. There is no rule against a maker submitting their own idea (like an originator), measuring demand, and then developing that idea. There is also no rule against a maker funding their own idea (like a bidder) and then developing that idea. As previously stated however, part of the novelty of the present invention is that users do not have to take on more than one role. Makers don't need to have the money to develop the product, nor do they need to figure out what product to develop. Makers can browse originator product ideas and see how much total money bidders are willing to pay to obtain them. A maker can choose to develop and produce a product if the maker has the relevant skills to fulfill the demand and if the maker believes he can make enough money selling the product to make the development/production effort worth his time.

By way of the exemplary methods 100, 200, and 300, fleshing out of specific product requirements is also crowdsourced. In each of the methods 100, 200, and 300, the web application provides an easy way for the three relevant stakeholders (originators, bidders, and makers) as well as those good at offering suggestions (henceforth referred to as “commenters”) to work together to refine product ideas. In such an embodiment, suggestions from stakeholders and commenters (henceforth referred to as “site users” when taken together) are posted in a public setting and can be upvoted or downvoted by other site users. Furthermore, site users can also comment on posted suggestions leading to further refinement of the ideas. Although the originator decides which suggestions from site users will become requirements, a bidder can make his bid a conditional bid to try to influence an originator to include or not include the requirements most important to him. If a bidder bids on a product with a conditional bid, the bid is only binding if the bidder's stated requirement preference is adopted by the originator. The site helps the originator to understand which requirements should or should not be included in order to retain the maximum number of bidders and money for his product idea.

Exemplary embodiments of the present invention provide that a maker is chosen to fulfill the aggregated demand for a product, service, policy change, or infrastructural project through an established process to be discussed below. In some embodiments, an originator can fulfill demand for his own product idea as an originator/maker, but more often these two roles will be filled by different entities.

Makers can be certified or uncertified. Certified makers differ from uncertified makers in that they are certified by the website (or a third party) as being both legitimate and experienced at their trade. Any maker can apply for certification from the site, but some makers may need to show a track record of success in fulfilling products through the website before they can be certified.

Uncertified makers that choose to develop and deliver a product will declare a unit price, declare an estimated date for delivering pre-orders, and deliver a finished prototype to the originator. Certified makers that choose to develop and deliver a product will also declare a unit price and an estimated date for delivery, but can deliver a presentation to the originator in lieu of a prototype. Similarly, all makers (certified or uncertified) that choose to provide a service, policy change, or infrastructural project will declare a price, estimated delivery date, and a presentation. Note that the term “offer” will sometimes be used to refer to either a prototype or a presentation and the term “offers” will sometimes be used to refer to prototypes or presentations.

In one embodiment of the present invention, originators examine offers in the order in which they are received and, after examination, decide whether or not the given offer adequately addresses the product vision and the requirements developed on the website. In some embodiments, if an originator agrees that a maker's offer has satisfied the vision and requirements, the maker will immediately be considered selected by the originator. In method 100, however, this is not the case.

In the method 100, the first maker with an offer satisfying the vision and requirements will not be immediately selected. Instead, upon receiving the selectable offer, the originator will declare the beginning of the proposal submission period. Announcement of the proposal submission period gives any additional makers currently working on an offer a deadline to submit their offers in order to be considered. Makers may submit more than one proposal, especially if they believe a competing maker may have submitted an offer which the originator prefers. If no other makers have submitted acceptable offers by the end of the proposal submission period, the first maker will become the selected maker. Otherwise, the originator will use his best judgment to make a decision on which maker to select. The website has many tools to help him make the decision, including maker profiles.

Both originators and makers have profiles on the website. Bidders and makers can look at an originator's profile to see the originator's biography, his history of success at managing past product ideas on the website, his approval rating on the website, reviews others have posted about him, and other information. If the bidder or maker sees things on the originator's profile which concern them, they may choose not to work with the originator.

Similarly, an originator can look at a maker's profile to see the maker's biography, if the maker is certified, his history of development and fulfilment of products on the website, his approval rating on the website, reviews others have posted about him, and other information. Maker profiles can help an originator make maker selection decisions.

Once a maker is selected by an originator, the unit price set by the selected maker is the minimum price that the originator and bidders must pay to receive a product from that maker. If the maximum “willing to pay” price of the originator or any bidder is greater than or equal to the unit price set by the maker, then that originator/bidder will receive a product.

In some embodiments, the nature of the product is important to determining the actual price paid by the originator/bidder receiving a product. If the “product” is a policy change or infrastructure project then: 1.) the maker's price is automatically set to $0 in order to ensure all contributions are included and 2.) an originator's or bidder's “willing to pay” price is the actual price paid by the originator/bidder.

In some embodiments, an originator's or bidder's “willing to pay” price is the actual price paid by the originator/bidder receiving a product regardless of the nature of the product. In other cases, only the unit price set by the maker is collected from the originator/bidder and any amount overpaid by the originator/bidder is returned to him (or never collected). Furthermore, if the maximum “willing to pay” price of the originator or any bidder is less than the unit price set by the maker, then this party's funds are returned (or never collected) and the maker has no obligation to provide this party with the pre-ordered product.

Once a maker is selected and a price set, a maker may decide if he wants to allow additional orders. If the maker agrees to accept additional orders, any underbidding entity (or previously non-bidding entity) that wants the product from the maker must pay a large price premium above and beyond the maker's set price in order to receive it. Note that makers may provide later estimated delivery dates for additional orders than the estimated delivery date provided in the maker's selected proposal. Also note that price premiums are often waived for policy changes and infrastructure projects.

In the area of delivering the final product, the present invention crowdsources to find the best maker for the job. The best maker for the job will be the one that can 1.) fulfill demand for the given amount of money pledged in pre-orders and 2.) adequately satisfy the product requirements laid out by the customers.

The presented embodiments dictate that only makers which can fulfill demand for the given amount of money can compete to fulfill the pre-orders for a given idea. In method 100, this process is self-selecting: the current aggregated amount of money from pre-orders is made publicly available to makers and, hence, makers that submit offers know how much money they will receive if chosen to supply a given product. Makers which cannot fulfill the pre-orders for the given amount of money have no motivation to compete.

Furthermore, the presented embodiments do not allow makers to fulfill pre-orders unless the maker can adequately satisfy the product requirements laid out by the customers. In the presented embodiments of the disclosed method, the originator for a given idea determines whether or not a maker has satisfied the idea's requirements through examination of the maker's offer for that idea.

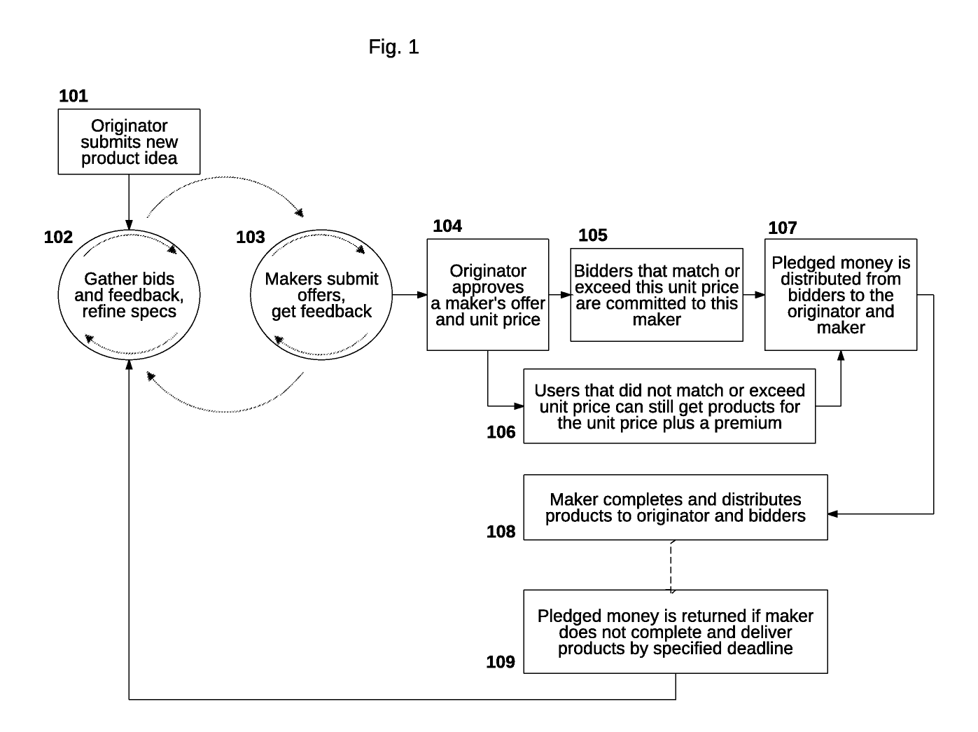

FIG. 1 illustrates a method 100 for simplifying product idea development, in accordance with an exemplary embodiment of the present invention. The method 100 begins with the initial submission of an idea for a product and ending in the distribution of said product in its realized form to the originator and other bidders. An originator first submits a product idea (step 101) with 1.) a first-pass of product specifications (e.g. fog-free goggles) and 2.) the maximum price he is willing to pay to pre-order the product. Over time other bidders see the product idea. These bidders can provide feedback on the specifications and make their own pre-orders each with their own “willing to pay” maximum price (step 102). In the method 100, a bidder may make changes to his “willing to pay” maximum price, although in other embodiments, changing bids is not allowed. When enough demand builds to warrant interest from a maker, makers will 1.) declare a price/unit at which they will fulfill the pre-orders, 2.) declare a delivery date for fulfilling pre-orders, and 3.) submit a prototype or presentation (an “offer”) to be reviewed by the idea's originator (step 103). Note that step 103 can lead to more interest in the product by other bidders, hence the circular feedback (arrows). Once the originator accepts an offer (step 104), the product specifications and “willing to pay” maximum prices are frozen (i.e. bids can no longer be changed and no new bids can be accepted). At this point, pre-ordering parties that matched or exceeded the unit price of this maker are automatically committed to pre-order from this maker (step 105). In some embodiments of the method 100, committed pre-ordering parties are committed to the unit price of the chosen maker, while in other embodiments, these parties are committed to the maximum “willing to pay” price they submitted. Furthermore, in some embodiments, the originator receives the product regardless of the “willing to pay” price he submitted as part of his compensation for coming up with the idea.

In the method 100, uncommitted bidders (including in some cases, the originator, if the originator's “willing to pay” price was too low) and those that previously never pre-ordered at all (“non-bidders”) are still given the option to purchase the product for the unit price plus a premium after an offer has been accepted (step 106). Most of the funds from pre-orders are transferred from the bidders to the maker, while some funds are also transferred to the originator and to the site (step 107). When completed products are ready, the maker fulfills the pre-orders and distributes the completed products to the originator and other bidders (step 108). If the maker fails to supply and distribute the products by the maker's declared delivery date then: 1.) all money collected for pre-orders from the failed maker is returned to (or never collected from) the pre-ordering parties as is as any price premiums charged to these parties (step 109), 2.) the original “willing to pay” prices of those pre-ordering from the failed maker are again set as the pre-ordering parties' “willing to pay” prices, and 3.) “willing to pay” maximum prices are no longer frozen, new bids can be collected, and the process returns to step 102.

As previously mentioned, the present invention utilizes a competitive free market mentality to drive results. A competitive free market mentality is a mentality governed by 1.) the pursuit of profit (and recognition), 2.) the spirit of competition, and 3.) economic demand curves—graphical representations of how many people will want a given product at different price points. This mentality provides motivation for the actions of all three of the major stakeholders: originators, bidders, and makers. It will be described how the present invention provides the appropriate environment to induce productive actions from these stakeholders in order to drive results.

First, it will be discussed how the present invention motivates originators using a free market mentality. In presented embodiments, the originator's bid for his product idea is the first data point for that idea's economic demand curve. Knowing that data points on the demand curve help makers decide whether or not to develop a product idea, originators make their best attempt to bid high enough to provide monetary incentive for makers.

Originator behavior is, in part, governed by the desire to obtain previously unavailable products. However, originator behavior is also governed, in part, by the desire to be recognized for innovative ideas and to compete with his peers to have the greatest number of said innovative ideas, especially successful innovative ideas. The presented embodiments publicly disclose information such as 1.) the number of product ideas authored by each originator, 2.) how many of those ideas were successfully undertaken by a maker, and 3.) the amount of total money successfully raised by each originator for successful ideas. In providing such information, these embodiments allow an originator to quantitatively compare himself to his peers and more easily set quantitative goals for surpassing and/or staying ahead of those peers. Thus, these embodiments create an environment which promotes healthy competition among originators and ultimately motivates the submission of increased numbers of successful ideas.

Originator behavior is also governed by the pursuit of profit: both short-term and long-term profit. Noodlecrumbs.com was a website meant to crowdsource ideas, but it failed to recognize the power of monetary incentives to promote the posting of ideas. In contrast, the presented embodiments realize the power of monetary incentives. In these embodiments, the majority of the money received for a given idea's pre-orders is awarded to an originator-selected maker as payment for the maker fulfilling the pre-orders. However, many of these embodiments also require that a percentage of the money from pre-orders be given to the originator of the idea in order to reward this originator for his innovation and management of the maker selection process. Using the method 100, as well as the methods 200 and 300 (to be discussed later), the originator receives a percentage of every sale regardless of which maker is producing and selling the product. Such a distribution of funds can provide monetary incentive for originators to 1.) turn suggestions from stakeholders into requirements, particularly those which are most often supported by bidders and 2.) select a maker (or makers) as quickly as possible. The reasoning will be described below in more detail.

Keeping bidder stakeholders happy is important to an originator since each bidder represents additional originator revenue. If an originator ignores a bidder requirement suggestion (especially one supported by many bidders in the form of upvotes or conditional bids), the originator runs the risk of the unhappy bidders withdrawing their pre-orders. If bidders are withdrawing that means lost revenue for the originator and even the possibility of no revenue. If the total sum of money pledged in pre-orders suddenly becomes too low to be of interest to makers, then the product will never get developed and the originator will never get any money for his idea.

In addition, keeping maker stakeholders happy is also important to an originator. If makers suggest downgrading requirements, there is probably good reason for it: they cannot make enough profit producing the product with the current requirements in order to produce for the “willing to pay” prices given by the originator and the bidders. If an originator ignores too many maker requirement downgrades then the originator might wind up with an idea that no maker is willing to take on and hence, again, the originator might not receive any revenue for his idea.

Furthermore, an originator will be motivated to select a maker (or makers) quickly. An originator will want to ensure product requirements are adequately fulfilled, but he also knows that earlier selection of a maker (or makers) will lead to short-term profit: the originator gets a percentage of the money received from pre-orders as soon he selects a maker (or selects the first maker).

In the method 100, the originator's pursuit of short-term profit competes with the originator's pursuit of long-term profit. In many embodiments, recall that the originator will decide, on behalf of the bidders, if the offer meets all the requirements. Hence, the originator is making the final decision on whether an offer matches what the bidders want. Bidders are more likely to place pre-orders when they are confident their product needs will be adequately fulfilled. If an originator gets a reputation for selecting makers who cannot deliver quality products, the originator may have difficulty obtaining bidders to support his future ideas (and lower bidder support implies decreased future profit/long-term profit). Furthermore, if an originator selects a maker who is unable to fulfill pre-orders as promised, all money received from those pre-orders must be refunded including the percentage of that money given to the originator. In other words, when an originator-selected maker fails to fulfill pre-orders, all money received by the originator in the short-term (after selecting an incapable maker) would be taken away from him in the long term (after the maker actually fails). Hence, the pursuit of long-term profit can influence originators to avoid hasty selection of a maker despite the promise of faster short-term profit gains. Hence, short-term profit motivation is provided for originators to select makers more quickly and long-term profit motivation is provided for originators to select quality makers.

The present invention also uses a free market mentality to motivate productive actions from bidders. Like originators, bidder behavior is partially governed by the desire to obtain previously unavailable products, but also partially governed by 1.) pursuit of profit, 2.) competition, and 3.) economic demand curves.

For a given idea, the presented embodiments provide a means for bidders to complete the economic demand curve started by the originator while they compete against each other to obtain the product they desire. In these embodiments, a selected maker will be motivated to set the price for a product as high as possible. When a selected maker sets a high price for a product, underbidders cannot purchase said product without paying a hefty price premium. Each bidder knows that, if he bids too far below his fellow bidders, he runs the risk of losing his opportunity to obtain the previously unavailable product he desires at a reasonable (not inflated by a price premium) price. Hence, bidders compete with each other on the amount of their bids: each wants to ensure they are not among the lowest bidders.

Note that bidder behavior is also motivated by the desire for short-term profits in the form of 1.) getting maximum value for their money or 2.) saving money. When suggesting requirements, bidders will be motivated to ask for as many features as possible in order to obtain maximum value. Furthermore, an incentive is provided for bidders to bid their true “willing to pay” price from the beginning (and save money) rather than underbid and pay the price premium later (a larger amount of money). Hence, economic demand curves with accurate data, data based on the true “willing to pay” prices of bidders, are more likely to be produced. It will be discussed later why economic demand curves with accurate data are important to makers.

Makers are the stakeholders most influenced by the competitive free market mentality of the presented embodiments. On one hand, maker behavior is governed by competition and pursuit of short-term profit. It is this competition and pursuit of short-term profit that motivates a maker to develop an offer which adequately addresses the requirements of a given idea in as short a time period as possible. A maker who develops an idea quickly can begin to make money from customers quickly, but a maker who develops an idea more quickly than his competitors will also be able to capture a larger percentage of available customers. The reason for this is simple: if a customer wants a product, he can only choose from the versions that are available. Once more versions are available, customers will be divided and some will choose the newly available versions. Hence, makers are motivated to develop a product early while customers have fewer choices about which version to buy.

In the method 100, makers are particularly motivated to develop a product before their competitors. In this embodiment, there is only one maker selected and that maker not only captures all the intellectual property rights, but also all the recognition and short-term profits. Very often this maker is the first maker who sends the originator an offer which addresses all the requirements. Actually, in many embodiments, the first maker who sends the originator an offer addressing the requirements is always the selected maker; however, in method 100, other makers are given the opportunity to try to submit offers within the proposal submission period (which, as previously stated, begins as soon as the first viable offer is received).

If the maker wants a chance at being selected, he has to be fast. Even if he is not fast enough to submit the first selectable offer, he has to be fast enough to submit before the end of the proposal submission period to have a chance at becoming the selected maker. The selected maker receives the majority of the money collected from pre-orders as well as exclusive rights to sell the resulting product if the idea is novel enough to receive a patent. Note that this maker must, of course, fulfill all the pre-orders to be able to retain these benefits.

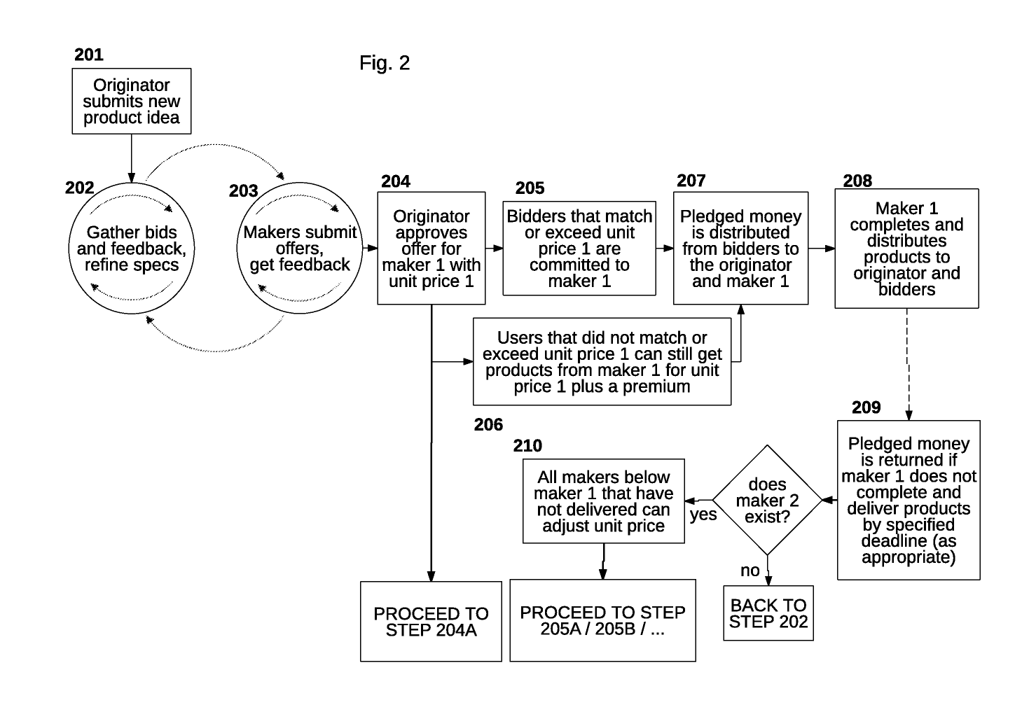

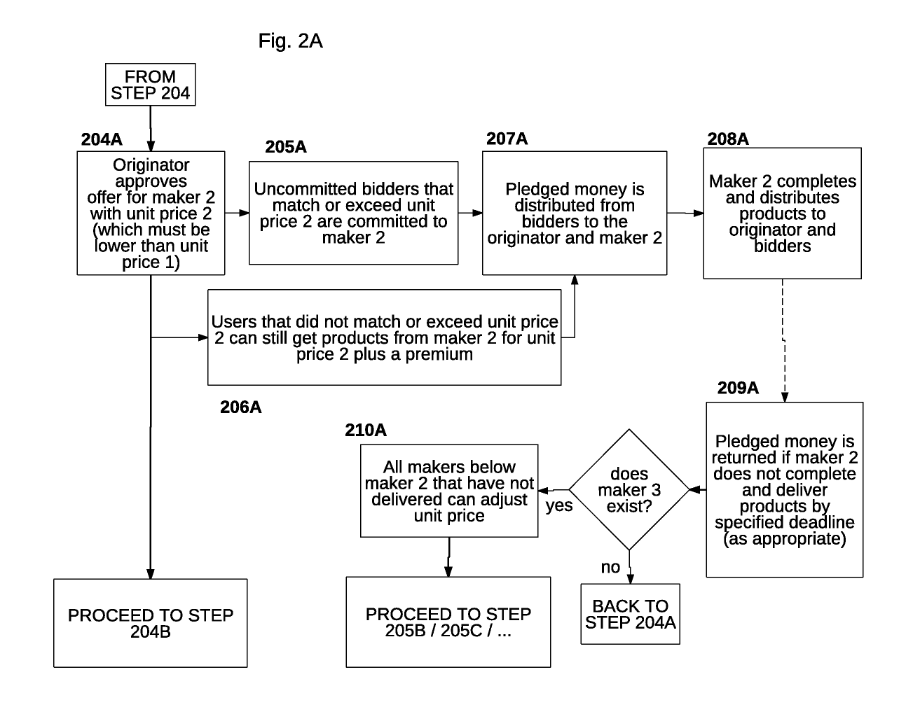

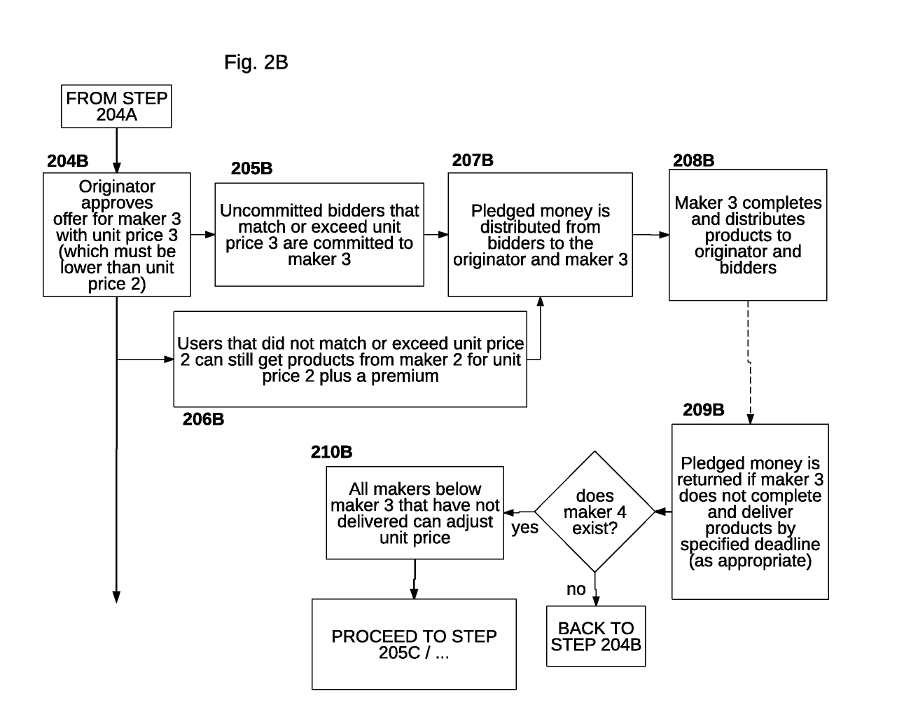

In another embodiment of the present invention, it is possible for multiple makers to fulfill pre-orders and share intellectual property rights, short-term profits, and recognition. This embodiment is illustrated in FIGS. 2, 2A, and 2B and is generally designated as 200, in accordance with an exemplary embodiment of the present invention. In the method 200, the originator still has the final authority on whether or not an offer addresses the requirements, but the originator can select more than one offer.

The method 200 does not include a proposal submission period. Instead, the first maker to provide the originator with a prototype/presentation which addresses the requirements will be immediately selected. A subsequent maker can present an offer to the originator for consideration, but subsequent makers may only be selected if they are willing to sell their version of the product at a lower price point than those of all the previously selected makers.

In the method 200, just like in the method 100, any party who submits a “willing to pay” price greater than or equal to the unit price set by the first selected maker will 1.) receive the desired product from the selected maker and 2.) pay only the unit price set by the selected maker (any overpaid amount will be refunded or never collected). Underbidders are treated differently however. Recall that, in the method 100, if a party submitted a “willing to pay” price less than the price set by the selected maker then 1.) the maker had no obligation to provide the underbidding party with the product and 2.) the underbidding party was refunded their money (or their money was never collected). For the method 200, underbidding parties do not automatically have their bids returned/never collected. Although parties bidding high enough have left the bidding pool with a completed transaction, underbidding parties can choose to remain in the bidding pool and postpone receiving any refunds they might be owed in the hope that a subsequent maker will be selected offering a version of the desired product at a lower price point.

As subsequent makers are selected in the method 200, overbidding is handled in the same way as it was for the first maker. As subsequent makers are selected, the maximum “willing to pay” prices of those remaining in the bidding pool are again examined. If a party's maximum “willing to pay” price is greater than or equal to the unit price set by the subsequent maker, then only the subsequent maker's unit price is collected from the party and any amount overpaid by the party is returned to that party/never collected. Any party bidding high enough to receive a selected maker's version of the product leaves the bidding pool with a completed transaction.

In the method 200, note that every time a subsequent maker is selected, that maker's unit price per product must be less than the unit price per product set by the previously selected maker. Subsequent makers can continue to be selected as long as the unit price per product set by the subsequent maker is greater than zero.

FIG. 2, FIG. 2A, and FIG. 2B illustrate the exemplary steps of the method 200. In the illustrated embodiment, steps 201-209 match steps 101-109 from FIG. 1. In the method 200, however, the originator can approve additional offers, provided that each approved offer submits a unit price lower than its predecessors (step 204A). Pre-ordering parties that had bid below the first maker's unit price but at or above the second maker's unit price will have pre-orders fulfilled by the second maker (step 205A). Steps 206A-209A are the same as steps 206-209 for the second maker, and steps 204A-210A apply to each subsequent offer that is approved by the originator (steps 204B-210B).

Still referring to FIG. 2, note that some embodiments are distinguished from each other in the same way as method 100: in some embodiments, bidders are committed to the unit price of the chosen maker, while in others, bidders are committed to the maximum “willing to pay” price they had submitted.

In further detail, still referring to the method 200, if a maker fails to supply and distribute products by the maker's declared delivery date, then, just like in method 100: 1.) all money collected for pre-orders from the failed maker is returned to (or never collected from) the pre-ordering parties, as well as any price premiums charged to these parties (step 209) and 2.) the original “willing to pay” prices of those pre-ordering from the failed maker are again set as the pre-ordering parties' “willing to pay” prices. After this, if the failed maker is the only maker with an accepted offer then the process is still the same as FIG. 1: “willing to pay” maximum prices are no longer frozen, new bids can be collected, and the process returns to step 202. However, in the case that there are other approved offers, the process is slightly different. First, money is returned to all parties pre-ordering from the failed maker or from any maker that: 1.) has not yet delivered any products and 2.) has a declared unit price less than that of the failed maker. Any price premiums charged are also returned to those pre-ordering from non-delivering makers with unit prices less than the failed maker. All pre-ordering parties with returned money become temporarily uncommitted to a maker. Next, any non-delivering maker with declared unit price less than the failed maker's unit price, has the option to increase their unit price (step 210/210A/210B . . . ) and change their delivery date. These makers are given this option in the order in which their offers were accepted by the originator. When it is a maker's turn to decide whether or not to increase their unit price, the maker can increase their unit price as high as desired as long as the new unit price does not surpass any currently declared unit prices. After each maker completes their unit price increase decision, “willing to pay” prices for uncommitted pre-ordering parties are examined to determine which parties are now committed to this maker, i.e. which uncommitted pre-ordering parties bid maximum “willing to pay” prices greater than or equal to this maker's unit price (step 205/205A/205B . . . ).

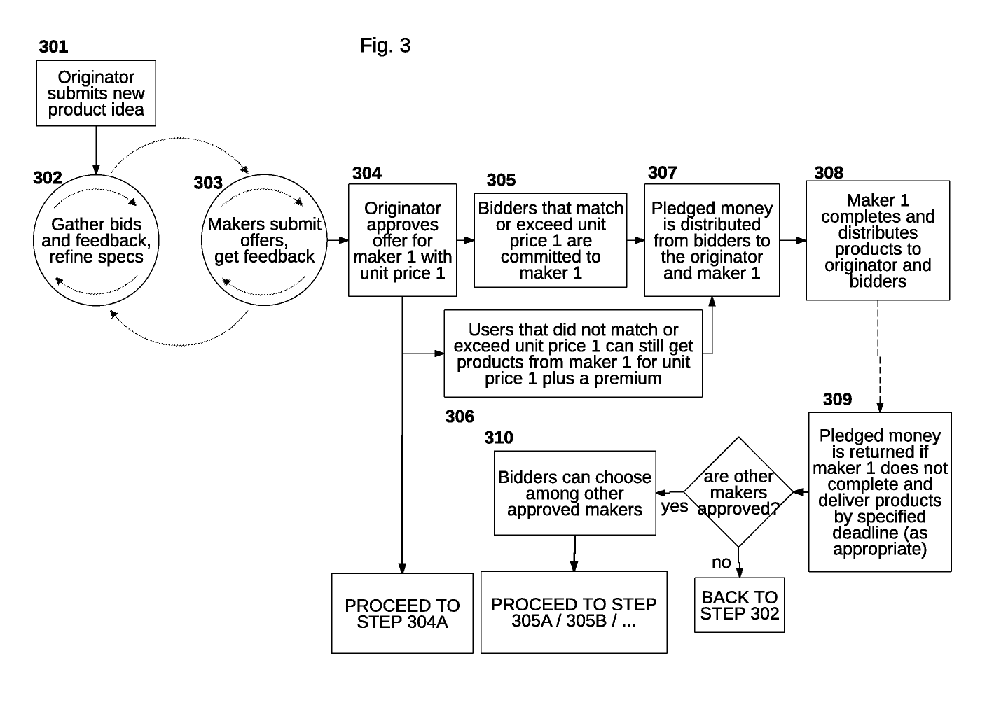

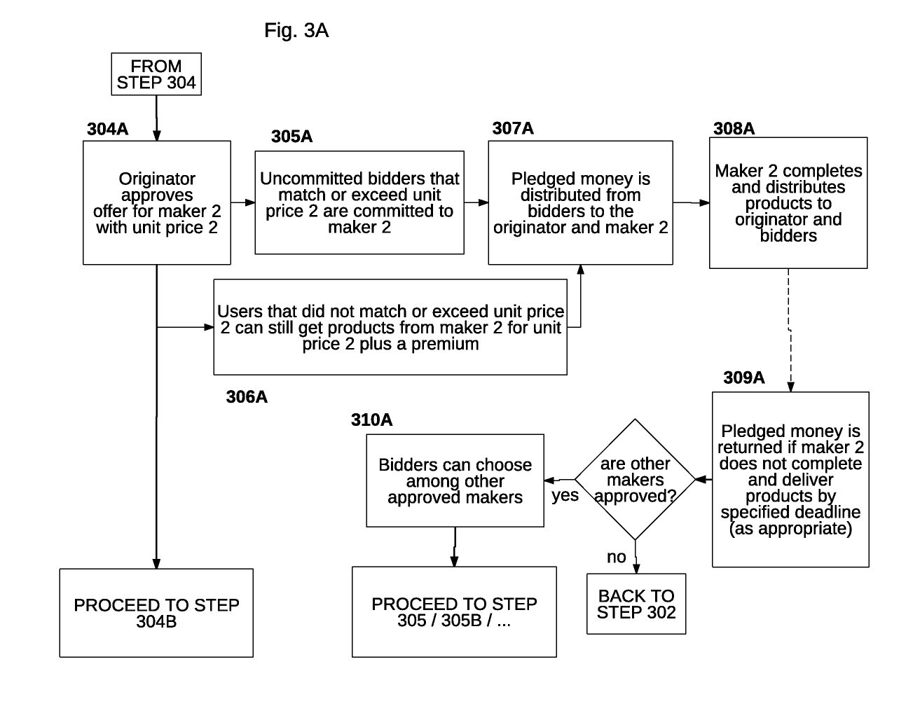

In yet another embodiment of the present invention, subsequent makers may set prices without restrictions and individuals may choose the maker from which they pre-order. An exemplary embodiment of a method, generally designated as 300, for setting prices without restrictions and in which individuals may choose a maker from which to pre-order is illustrated in FIGS. 3, 3A, and 3B, in accordance with an exemplary embodiment of the present invention. Much like the method 200, the method 300 includes no proposal submission period. Also like the method 200, the method 300 allows multiple makers to fulfill pre-orders while sharing intellectual property rights, short-term profits, and recognition. For the method 300, the originator still determines which offers satisfy requirements, but the originator and all bidders each individually choose the maker he wants to order from. As offers are approved by the originator, the submitting makers become vendor options for the bidding parties to choose from.

Furthermore in the method 300, just like the method 200, underbidding parties do not automatically have their bids returned/never collected. Again, underbidding parties can choose to remain in the bidding pool in the hope that a subsequent maker will be selected offering a version of the desired product at a lower price point.

A major difference between method 300 and method 200 is that method 300 gives overbidders more options. In method 300, if the maximum “willing to pay price” of the originator or any bidder (the party) is greater than or equal to the price set by a selected maker, this party may either 1.) choose the maker to fulfill his pre-order or 2.) remain in the bidding pool and wait to see if another maker is selected with an offer that the party prefers. A party can choose any selected maker to fulfill his pre-order, as long as the selected maker set a unit price less than or equal to the party's “willing to pay price”. Once a maker is chosen by the party, the process is much like systems 100 and 200: the chosen maker's unit price is collected from the party, any amount overpaid by the party is returned (or never collected), and the chosen maker will fulfill the pre-order before the estimated date of delivery.

One way method 300 differs from both method 200 and method 100 in that selected makers can give different estimated delivery dates to different overbidders. This makes sense since in method 100 and method 200: 1.) selected makers have prior knowledge of the number of initial pre-orders they will have before selection and 2.) these initial pre-orders are allocated to the selected maker as soon as the maker is selected. With method 300 however, neither of these are true. With method 300, there are no guarantees on the number of pre-orders they will receive and an overbidder may choose a selected maker to fulfill his pre-order at any time after the maker is selected. With such uncertainty, it is harder for the selected maker to plan ahead and hence, the selected maker may give an overbidder a later estimated delivery date if the overbidder takes longer than other overbidders to choose him as the selected maker to deliver his pre-order.

In addition, method 300 differs from both method 200 and method 100 in several other ways. First, a method 300 bidder who pre-ordered more than one product may allocate his order to more than one selected maker. For example, if the bidder pre-ordered four of the product he might choose a first selected maker to fulfill one of those pre-orders, a second selected maker to fulfill another of those pre-orders, and a third selected maker to fulfill the final two pre-orders. Second, a method 300 originator may have more than one set of requirements that makers may choose to follow when developing their product. Each set of requirements will be more or less identical with only slight variations. These variations can be used to address conflicting conditional bids from method 300 bidders. For example, one bidder may request a product to be red in order for his bid to be binding and another bidder may request a product to be anything but red in order for his bid to be binding. Having two sets of requirements allows both of these bidders to remain in the bidding pool and leave the door open for makers to fulfill pre-orders for both product variations.

Finally, it is important to note that method 300 differs from method 100 and method 200 in that it is the only one of these three embodiments which allows multiple entities to fulfill policy changes or infrastructure projects.

FIG. 3, FIG. 3A, and FIG. 3B describes the overall process for method 300. In this embodiment, steps 301-304 and 306-309 match steps 101-104 and 106-109 from FIG. 1. Method 300 is similar to method 200 in that the originator can approve additional offers, however, in method 300 the unit price set by each subsequent maker does not have to be lower than the unit price set by preceding makers (step 304A and 304B).

Still referring to FIG. 3, another distinct characteristic of method 300 is that pre-ordering parties can choose to commit to any approved maker that their bids can afford (step 305/305A/305B . . . ). As soon as a new maker's offer is approved (steps 304/304A/304B . . . ), each pre-ordering party can: 1.) choose to apply his pre-order to that maker if the pre-ordering party's maximum “willing to pay” price is greater than or equal to the new maker's declared unit price or 2.) wait and see what other maker offers are approved and then decide later which maker he wants to pre-order from. Once a pre-ordering party commits a pre-order to a maker, he cannot commit the pre-order to another maker, unless the maker fails to fulfil the pre-order as promised (to be described in further detail). Also, once a maker offer is approved with a unit price less than or equal to a pre-ordering party's maximum “willing to pay” price, that pre-ordering party is committed to ordering from a (current or future) maker and cannot get his money returned (or never collected) except in extenuating circumstances. These extenuating circumstances occur if the only makers with declared unit prices less than or equal to the pre-ordering party's maximum “willing to pay” price are makers which have failed to supply and distribute products by their declared delivery dates.

In further detail, still referring to FIG. 3, steps 304A-310A and steps 304B-310B are the same as steps 304-310 for subsequent makers with offers approved by the originator. In addition, some embodiments of method 300 are distinguished from each other in the same way as method 200 and method 100: in some embodiments, bidders are committed to the unit price of the chosen maker, while in others, bidders are committed to the maximum “willing to pay” price they had submitted.

Referring to the invention of FIG. 3 in still further detail, if a maker fails to supply and distribute products by the maker's declared delivery date, then, once again: 1.) all money collected for pre-orders from the failed maker is returned to (or never collected from) the pre-ordering parties, as well as any price premiums charged to these parties (step 309) and 2.) the original “willing to pay” prices of those pre-ordering from the failed maker are again set as the pre-ordering parties' “willing to pay” prices. After this, if there is only one maker with an accepted offer then the process returns to step 302, but if there are other approved makers, those pre-ordering from the failed maker can select any new maker which they can afford based on their original “willing to pay” price (step 310).

For systems 100, 200, and 300, selection of the first maker is the event that initiates price premiums (except in the case of policy changes and infrastructure projects). Once the first maker is selected, any non-bidding entity that wants a product (as well as any underbidder that wants a product in method 100) must pay that maker's unit price plus a large price premium in order to receive it. In systems 200 and 300, underbidders who voluntarily leave the bidding pool have the same status as non-bidding entities: in order to get a product from a maker they must pay that maker's unit price plus a large price premium. Note that if an underbidder remains in the bidding pool after a first maker is chosen he might still have to pay a price premium. If a maker sets a unit price higher than an underbidder's maximum “willing to pay” price, the underbidder must always pay the maker's unit price plus a price premium in order to get the product from that maker.

Once a maker is selected, only “underbidders” can leave the bidding pool and get a full refund. In method 300, it is important to note that a party in the bidding pool can only be considered an “underbidder” if the party has submitted “willing to pay” price less than the unit prices set by all currently selected makers. Said another way, a party's right to a full refund is lost as soon as a maker is selected with a unit price less than the party's “willing to pay” price.

For systems 100, 200, and 300, it has been discussed how competition and desire for short-term profit motivate makers to quickly develop offers that meet requirements. For all three embodiments, if a maker takes too long to develop, it can result in a loss of business to a competitor; makers compete against each other to be the first to develop and thus capture customers and short-term profit gains. In method 100, the process is winner-take-all, the first maker to be selected is the only maker to receive money collected from pre-orders. In method 200, there can be more than one selected maker, but there still is motivation to be the first. The first selected maker of method 200 is the only maker who can set a price for the product without restrictions and can set the price to capture the greatest number of customers and/or make the most short-term profit. Subsequently selected makers in method 200 can only attempt to capture short-term profit from the remaining potential customers: makers that developed faster and were previously selected will have already captured the money collected for pre-orders from the higher-bidding customers. Even in method 300 there is significant short-term profit motivation to develop early and capture business from any originator or bidder anxious to receive the product they desire as quickly as possible (and not wait for the offerings from other makers to be released).

On the other hand, a maker's desire for short-term profit can be tempered with his desire for long-term profit. If a maker rushes to submit a prototype or presentation which is still very rough and in need of refinement, the maker runs the risk of obtaining a reputation for poor quality. Websites like SellanApp (sellanapp.com) and Assembly (assemblymade.com) allow products (in this case, smartphone apps) to be produced by makers, but the websites require that the makers themselves remain in anonymity. With these sites, apps are not linked to makers, but are respectively declared to be made by SellanApp (sellanapp.com) or Assembly (assemblymade.com). In the presented embodiments, this is not the case: makers' names are attached to their work and their record of success or failure is made public to originators. Makers may like short-term profits, but their chance at long-term profits is more assured if their track record is such that future originators will want to work with them. Originators certainly may consider track record when selecting a maker. If a maker does not have a track record for developing quality products (or worse, they have a poor track record for fulfilling pre-orders after being chosen by an originator), then the maker will have a tougher time getting future originators to select them.

The presented embodiments also provide a means to temper a maker's desire for short-term versus long-term profit when the maker suggests requirement changes. On one hand, the maker will want to suggest requirement changes which make the product less expensive to produce; lower costs would increase the maker's short-term profit if the maker were to become selected. On the other hand however, the maker will want to be known for making the best products and listening to the requests of his customers.

It should be noted that a maker uses the previously presented economic demand curves to help realize: 1.) the maximum revenue which can be obtained from pre-orders of a particular product and 2.) what unit price the maker should set for the product in order to achieve said maximum revenue. As previously mentioned, makers believe the accuracy of the economic demand curves are very important. In order to have monetary incentive to take on a product development effort, a maker will want to ensure that the maximum revenue obtainable from product pre-orders is significantly higher than the cost to fulfill those pre-orders. If the originator and the bidders all underbid their true “willing to pay” prices, then the demand curve would underestimate both the optimal product unit price and the calculated maximum possible revenue for a maker. It may be that the actual optimal price and maximum possible revenue (those based on true “willing to pay” prices) would be profitable enough to convince a maker to take on a product development effort. However, with an inaccurate demand curve and artificially lower numbers, the same maker might pass on the same product development effort if there is not enough monetary incentive. The opposite can also have negative effects: an overestimated optimal unit price and maximum possible revenue might mislead makers into an effort which might not be cost effective if no future customers can be found to buy the product at the same price point. Hence, the presented embodiments seek to provide accurate demand curves to provide makers with the correct information on which to base their product development decisions.

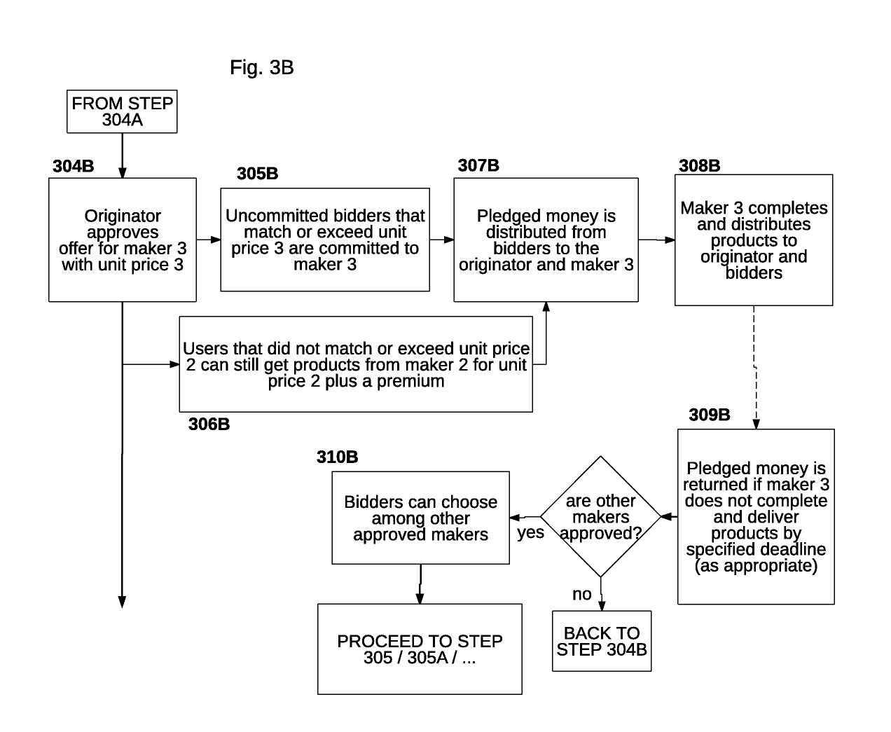

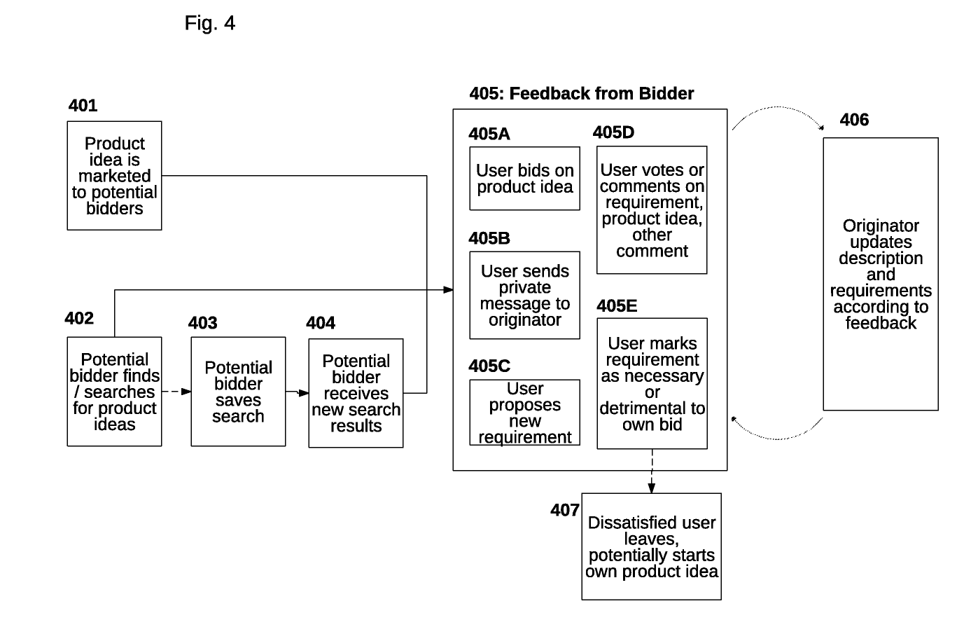

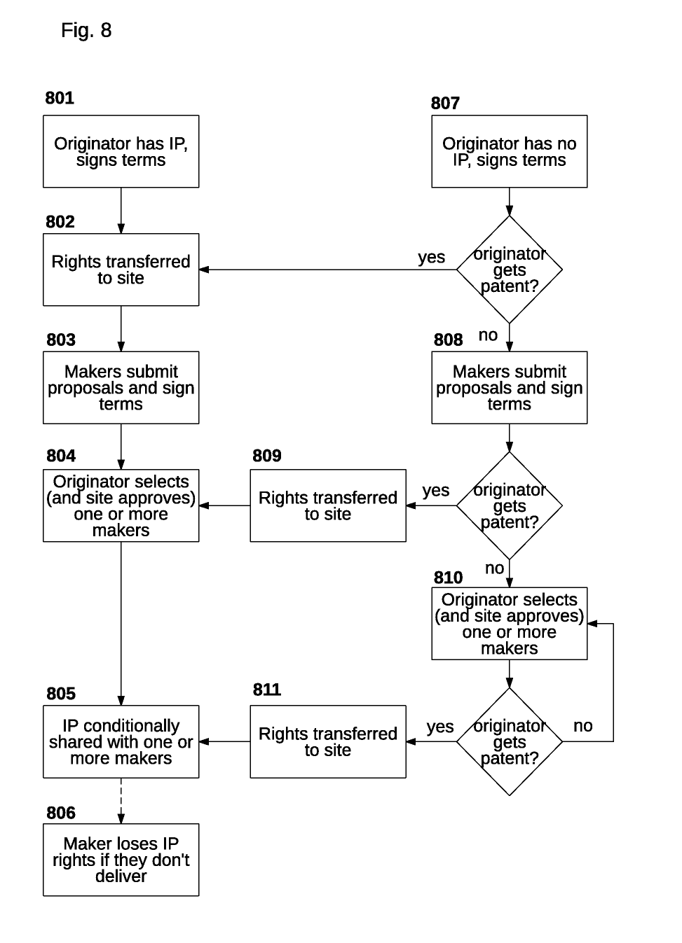

FIG. 4 provides an exemplary embodiment for how the gathering of pre-orders and the refinement of requirement specifications may occur. A bidder may find out about a product idea through several processes: he may receive information about it with a hyperlink (step 401); he may find the product idea using a browser-supported keyword search (step 402), or he may save said search (step 403) and subscribe to be alerted by email when new matches appear (step 404). Once a potential bidder is engaged with a product idea, he may bid by declaring a “willing to pay” maximum price. In addition, the bidder and other users may provide feedback about the product description and the product requirement specifications through the system website (step 405). Such feedback can be given in many ways including but not limited to: bidding on the product idea (step 405A); sending the originator a private message (step 405B); proposing a new requirement (step 405C); voting or commenting on the current description, requirement specifications, or the comments of others (step 405D); or marking a requirement as critical or detrimental to their own bid (step 405E). The originator may respond to all the described forms of feedback by modifying the product description and requirements accordingly (step 406). Steps 405 and 406 can feed into each other, as other bidders and the originator can respond to the feedback with more engagement. Note that a user can use step 405D to place a conditional bid. If all critical requirements of the conditional bid are accepted by the originator and all detrimental requirements of the conditional bid are removed/rejected by the originator, the amount of the user's conditional bid is binding. If these conditions are no longer met while the user is an active bidder, the bid ceases to be binding. If a potential bidder's conditions are not met, he may start his own version of the product idea (step 407) and attempt to gather his own bidders (note: such action requires that the original product idea not be restricted by originator intellectual property; intellectual property concerns are explained further in the description of FIG. 8).

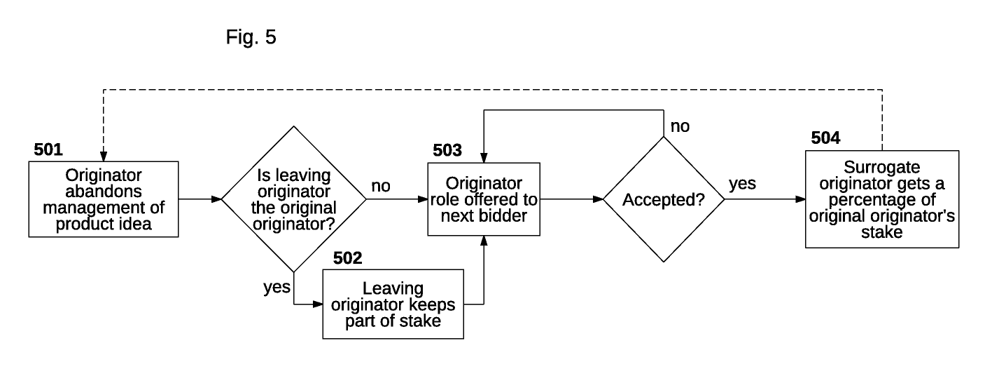

FIG. 5 gives detail on an exemplary embodiment of the originator preservation process. An originator may withdraw from a product idea using the system site (step 501), but if a surrogate originator is found, the product idea can continue to aggregate demand, refine its specifications, and undergo development by a maker. The leaving originator will be entitled to a small percentage (a smaller percentage than if he had not left) of the raised funds if a deal is reached (step 502) and the next pre-ordering bidder in chronological order will receive a message from the system site with an offer to take over the role of originator (step 503). If the bidder accepts the offer, he will be entitled to a percentage (a smaller percentage than if he was the true originator) of the raised funds (step 504). If the bidder does not accept, the offer will be passed to the next bidder in line, and the process from step 503 will continue until a bidder accepts the role (if no current bidders accept the role, the role will be offered to the next bidder who bids on the product idea). If a surrogate originator later withdraws from the product idea, the process returns to step 503 without an entitlement to the withdrawing surrogate bidder.

Still referring to FIG. 5, an accepted offer could also lead to step 501 in some embodiments, if 1.) there are bidder preferences that were not met in the accepted offer and 2.) the originator declines to post a new idea based on those bidder preferences. In some embodiments, the originator has the option of posting a new idea based on the differing sets of requirements and, in some embodiments, a disenfranchised bidder (one whose preferred requirements are not met) also has the option of posting a new idea based on the differing sets of requirements.

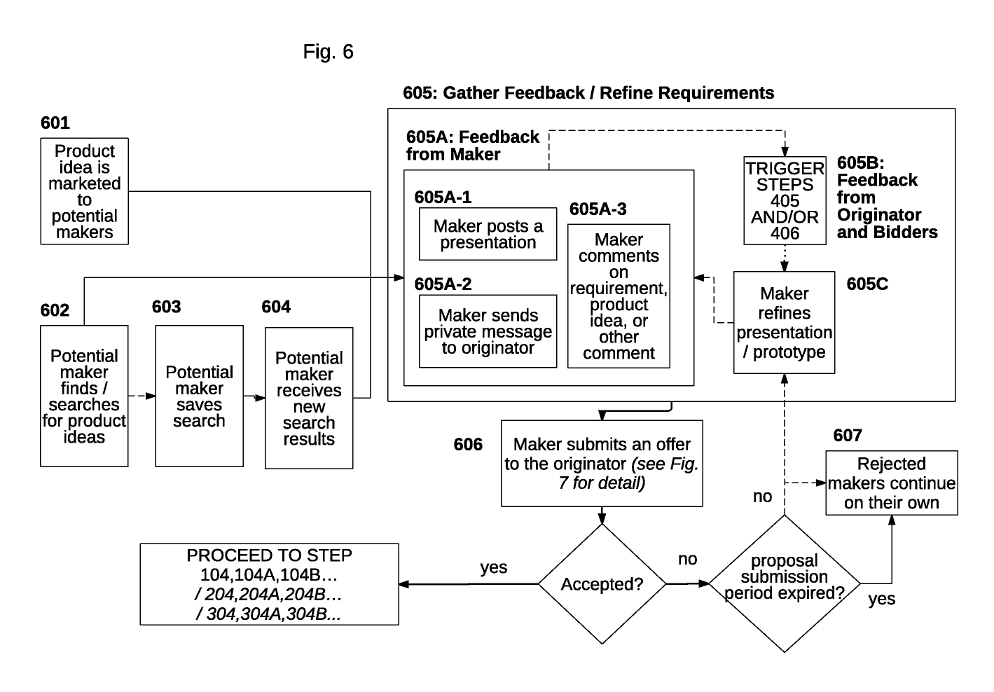

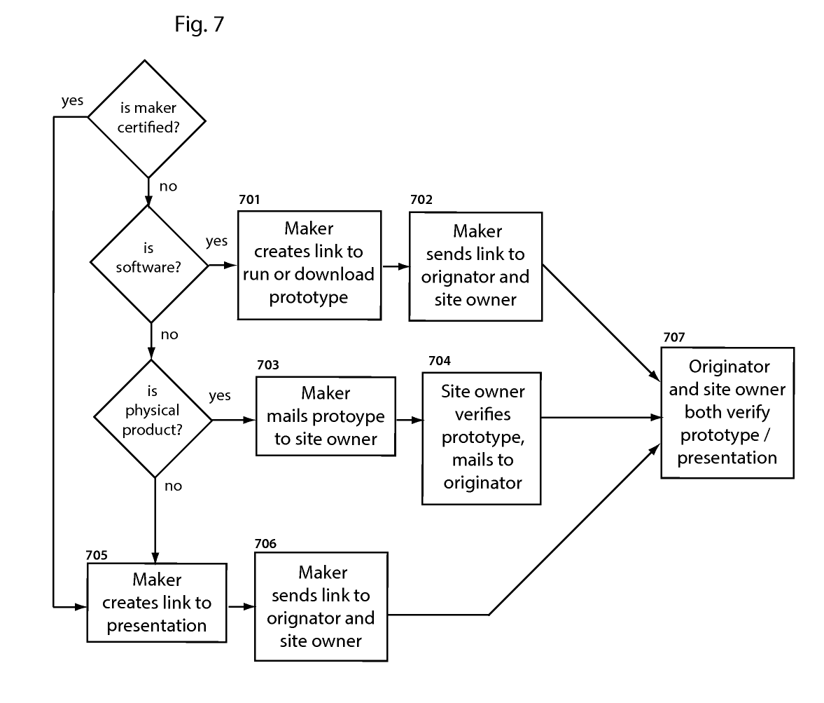

FIG. 6 gives detail on an exemplary embodiment of the maker quoting and feedback process. A maker may find out about a product idea through a hyperlink to the product idea's URL on the system's website (step 601). The maker may also find product ideas by browsing the site or using a browser-supported search, which provides search criteria such as category and keywords (step 602). For browser-supported search, the maker can save searches (step 603) and subscribe to be emailed with new results (step 604). Once a product idea has captured the interest of a maker, the maker can engage the originator and/or other bidders (step 605A) in a number of ways including but not limited to: posting a presentation of planned realization of the product (step 605A-1); sending the originator a private message (step 605A-2); or publicly voting or commenting on the current description, requirement specifications, or the comments of others (step 605A-3). Step 605A can re-trigger steps 405 and 406 (step 605B) such that the originator and bidders can provide feedback to the maker. Interaction between the originator, bidders, and maker may influence the specifications of the product and may also influence the maker's presentation and planned realization of the product (step 605C). At any point in step 605's overall process, the maker can submit an offer to the originator including a unit price quote, a projected delivery date, which requirements will be met, and a prototype/presentation as appropriate (step 606, prototypes are delivered for physical products from non-certified makers, presentations are delivered for products from certified makers, and presentations are delivered for non-physical products, services, policy changes, and infrastructural projects from any type of maker). To help a maker with in determining his unit price quote, the system site displays a graphical representation of the demand curve. This graphical representation shows the number of bidders who would become customers at any proposed unit price. In terms of prototypes/presentations, the nature of the prototype/presentation depends on the nature of the idea. For example, if the product idea is for a software application for a mobile device, the prototype could be a demo version of said application (see FIG. 7 for detail). Once the originator receives the prototype, he may either accept it or reject it. If he rejects the prototype, the prototype is returned to the maker. The originator may provide feedback to the maker regarding the reason the prototype was not approved and the maker can either refine his offer and resubmit (step 605C), or leave this process (step 607) and potentially sell the product outside of the site (note that selling the product outside the site is only possible if the product is not patentable, see FIG. 8 for details). If instead the originator accepts the prototype, the process proceeds to step 104 (method 100), 204/204A/204B/ . . . (method 200 with entry point depending on the quantity of other makers with accepted offers), or 304/304A/304B/ . . . (method 300 with entry point also depending on the quantity of other makers with accepted offers).

FIG. 7 provides detail on an exemplary embodiment of the transfer of prototypes. If the nature of the product idea is software, the maker creates a link to run or download the prototype (step 701) and sends said link to both the originator and the owner of the system site (step 702). For example, if the product is an iOS app, the maker can upload a demo version of the app to a service such as TestFlight that allows others to sign up and download the demo app onto their own devices. If the nature of the product is hardware or another physical product such as clothing, the maker mails a prototype to the site owner (step 703). The site owner will verify its existence and forward it to the originator (step 704). If the nature of the product is neither physical nor software (e.g. a service, policy change, or infrastructural project), then the maker creates a link to a presentation (step 705) and sends the link to both the originator and site owner (step 706). At the end of all these scenarios, both the originator and site owner will verify the existence of the prototype and acknowledge receipt on the system site (step 707).

FIG. 8 provides detail on an exemplary embodiment of the transfer of intellectual property for ideas that are patentable (or already patented). In order to submit a patentable (or patented) idea (invention), the originator must accept terms and conditions that require him to transfer exclusive intellectual property rights to his invention. These terms and conditions state that the originator agrees to give the site the exclusive rights to the originator's invention with the understanding that these rights will be shared with a maker (or makers) at such time (or times) that a maker is (or the makers are) approved by the site. In most cases, any maker selected by the originator will be approved by the site, but the site maintains the right to withhold approval if it deems fit to do so.

An originator may publicly disclose a patentable product idea on the system site at any time, regardless of whether or not he has yet obtained any rights related to its intellectual property. In step 801, an originator who already has a patent discloses his invention on the site and signs the terms and conditions. In step 807, an originator without a patent discloses his invention on the site and signs the terms and conditions. For submitted patentable inventions that have not yet received a patent, the terms and conditions state that exclusive rights will be transferred to the site as soon as a patent on the invention is obtained. After signing the terms and conditions, exclusive rights to the invention are transferred to the site if the originator has a patent (step 802) or as soon as he obtains a patent (steps 809 and 811).

Makers submitting proposals also must sign terms and conditions (steps 803 and 808). The terms and conditions signed by a maker state, without limitation, that, if 1.) the idea is patented or ever patented and 2.) the originator selects and the site approves the maker (steps 804 and 810), the exclusive rights to the idea will be shared with them (step 805). The terms and conditions also state, without limitation, that any approved maker that fails to supply and distribute the products by their declared delivery date can lose the rights to the intellectual property (step 806).

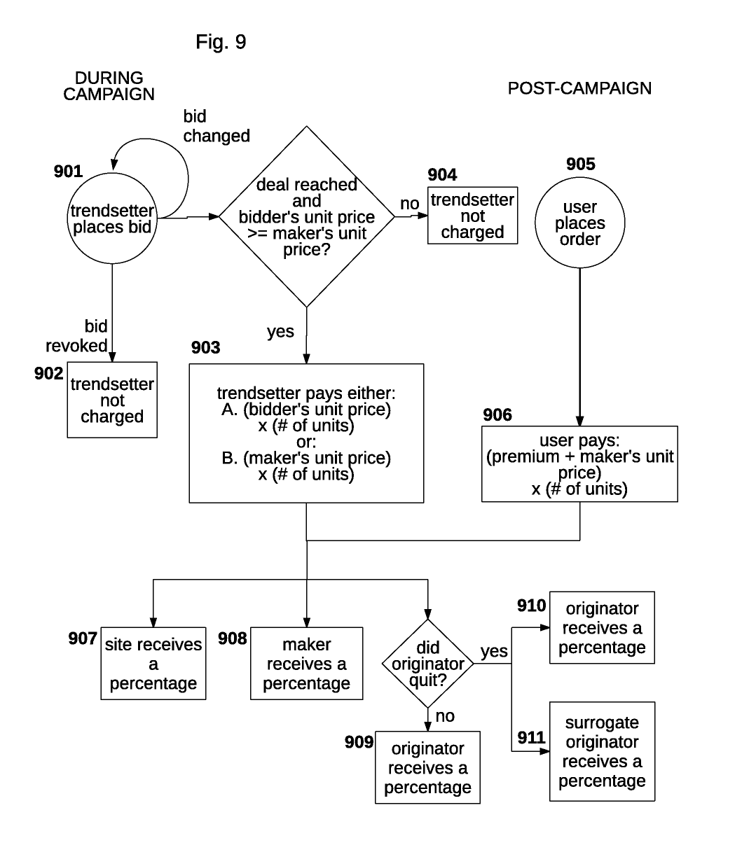

FIG. 9 provides detail on one exemplary embodiment of the transaction process. Once a product idea is posted to the site, originators and other bidders can each provide their personal bid, i.e. their maximum “willing to pay” price to pre-order the product (step 901). In this embodiment, each bidder can also change or revoke his existing bid. If no maker steps forward to fulfill the demand for the product idea, bidders are never charged (step 902). On the other hand, if a maker is chosen to fulfill pre-orders, the maker sets a unit price and no further changes to existing bids are allowed.

After a maker is chosen, any bidder bidding at or above a maker's unit price is now charged (step 903). In some embodiments, an originator's or bidder's “willing to pay” price is the actual unit price paid by the originator/bidder receiving a product. In other cases, the bidder pays only the maker's unit price and any amount overbid by the originator/bidder is returned to him (or never collected). In either of these embodiments, the set unit price is multiplied by the number of units the originator/bidder has pre-ordered.

Any bidder bidding below the maker's unit price is never charged for the bid (step 904), but can still pre-order the product if the maker continues to accept new pre-orders after being chosen (step 905). Other users, who didn't previously bid, can also enter the process from step 905. A premium is applied to the unit price for pre-orders after a maker is chosen, so the user pays both the premium and the unit price for the product, multiplied by the number of units he has pre-ordered (step 906).

Still referring to the embodiment of FIG. 9, the funds collected from bidders are distributed among the site (step 907), maker (step 908) and originator (step 909) according to percentages established by the site and/or users. In some embodiments, the funds are distributed in a lump sum to the receiving parties, while in other embodiments the funds are distributed more slowly to one or more of these parties as originator-determined milestones are achieved (e.g. completed setting up a factory to mass produce the product). Systems 100 and 200 both allow funds to be distributed more slowly. In embodiments where the funds are distributed more slowly, the site: 1.) provides forms to ask an originator for his milestones, 2.) provides forms to allow makers to indicate completion of milestones, 3.) provides forms to allow an originator to disperse additional funds as makers indicate completed milestones, and 4.) keeps track of which milestones have been completed (according to the maker), how much money has been dispersed by the originator, and how much money still needs to be dispersed.

In further detail, still referring to the embodiment of FIG. 9, the originator may have resigned his/her role before an offer was accepted (see FIG. 5). If originator resignation has occurred, the originator's share of the collected funds is split between: 1.) the first originator and 2.) the user that served as surrogate originator when the deal was reached (steps 910 and 911). Note that depending on the payment processing service used by the embodiment of the invention, any of steps 903 and 905-911 may incur a processing fee collected by the service.

Modifications could be made to the embodiment of FIG. 9 without loss of generality. For example, other embodiments are envisioned such that all bidders are charged immediately upon bidding and/or no bidder can change or revoke their bid. In embodiments in which: 1.) only one maker is chosen to fulfill pre-orders and 2.) bidders are charged immediately, refunds to overbidders (for the amount bid above the maker's unit price) and to underbidders (for the full amount of their bid) occur as soon as the maker is chosen. In embodiments in which: 1.) multiple makers may be chosen to fulfill pre-orders and 2.) bidders are charged immediately, an overbidder refund (for the amount bid above the maker's unit price) occurs as soon as a particular maker is assigned to fulfill the overbidder's pre-order and an underbidder refund occurs when at least one maker is chosen and the underbidder asks for a refund (note that if a bidder bids higher than or equal to the unit price of any maker, this bidder is not an underbidder, but an overbidder).

Refunds can be directly returned to the bidder or offered as site credit for future bids. In some embodiments, both overbidders and underbidders are forced to pay their full bid regardless of the unit price (or prices) set by the one or more makers. Additional funds generated as the result of these alternative overbidding/underbidding rules are distributed with varying percentages to the site, the originator, and the maker. In some embodiments, if the funds come from overbidders they can be distributed differently than they are if the source of the funds is from underbidders.

Rules governing what percentage of collected funds should go to each party can be determined by a variety of methods depending on the embodiment. The percentage given to each party could be permanently fixed or allowed to change based on contingencies. In some embodiments, such contingencies include using measures of successful tenure on the site to warrant an increasing a party's percentage of collected funds. Without limitation, these measures of success could include: 1.) a large number of successfully fulfilled pre-orders (for makers), 2.) a large number of ideas resulting in bidders, collected funds, and/or fulfillment (for originators), and/or 3.) a large amount of positive feedback from other users of the site (both makers and originators).

In other embodiments, supply and demand are used to determine the percentage of collected funds allocated to the site, originator, and maker. If very few ideas are being posted for a certain genre of product (say t-shirts), then the percentage of collected funds given to originators posting t-shirt ideas might be allowed to increase in order to encourage more such ideas. Furthermore, if there are lots of t-shirt ideas being posted on the site and very few makers are producing t-shirts, the percentage of collected funds given to t-shirt makers might be allowed to increase to encourage makers to start fulfilling t-shirt pre-orders.

In further embodiments, the division of collected funds can be negotiated between parties. In such embodiments, the website provides appropriate web forms to simplify such negotiations. An originator might post an idea along with the percentage of collected funds he is willing to give to a chosen maker. Makers might respond by saying they'd be willing to submit an offer if the maker percentage they might receive was higher. In addition to percentage of collected funds, web forms provide additional options for what form of compensation might be negotiated, including royalties on future sales and/or a direct exchange of funds. Compensation can be promised in absolute or conditional terms (example: if milestone X is achieved, then originator is entitled to a higher percentage) and the website keeps track of the current agreement between the parties.

Similarly, some embodiments provide web forms to provide for negotiation between an originator and a surrogate originator. Again, the website keeps track of the current agreement. In these embodiments, surrogate originators can be chosen by the initial originator of an idea under certain agreed upon conditions. Furthermore, the site can make available profiles for “project managers” who wish to manage the development of product ideas along with public feedback received by these project managers and their track record for success on the site.

In yet further embodiments, profiles of project managers are made available to makers who wish to collaborate on fulfilling a product idea. For example, some product ideas may require a maker with knowledge of mechanical engineering and electrical engineering. In such an example, a maker skilled in mechanical engineering may wish to collaborate with a second maker who has electrical engineering knowledge. For these embodiments, a project manager may be unanimously selected by the one or more makers. Next, web forms are provided to record the agreement between the parties regarding how profits are to be divided among them. Finally, for the purposes of providing a point of contact for the originator and bidders bidding on the product idea, the project manager acts as the representative for the collaborating makers.

In summary, provided herein is a method to a.) crowdsource and aggregate product ideas in a way which encourages participation from any entity, b.) crowdsource and aggregate demand and feedback for each idea, c.) crowdsource and aggregate funding for each idea for necessary product development, sourcing, creation, execution, and/or delivery of the idea, d.) crowdsource and aggregate those with the know-how to develop, source, create, execute, and/or deliver a product idea, e.) determine which of those with know-how should be selected to develop, source, create, execute, and/or deliver the idea, and f.) provide the tools necessary for the selected entity to view feedback and demand information in a meaningful way, receive necessary funding, and ultimately fulfill the demand for the idea the entity was selected. All of this is done utilizing a competitive free market mentality to drive results.

Also provided herein is a system for implementing this method. The system includes a web application and a computer network. The computer network includes, without limitation, numerous client machines and a server connected to these numerous client machines. Each client machine includes, without limitation, a user interface and a browser. The server includes, without limitation, a memory module and a processing device.

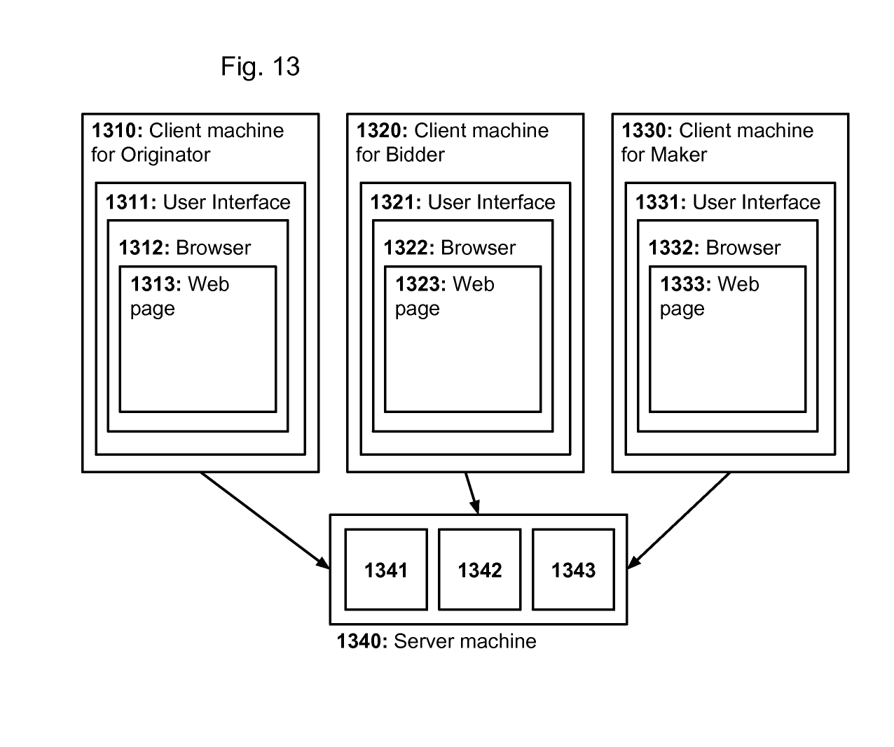

FIG. 13 provides detail on one possible physical embodiment of such a system. The client machine shown in step 1310 serves as the control interface for the originator. The client machine shown in step 1320 serves as the control interface for the bidder. The client machine shown in step 1330 serves as the control interface for the maker. All three machines interact with a server (step 1340) via Ethernet connection.

The server machine's memory module (1341) provides significant storage space in order to aggregate information about users of the web application, including, without limitation, their ideas, their feedback on ideas, and their indicators of demand (such as how much they are willing to pay for a product). The memory module also provides the means to tangibly store the software code which comprises the web application. This software code is executed by the server machine's processing device (1342). Examples of “processing device” include a general purpose microprocessor, a microcontroller, a central processing unit, an ASIC, etc. The processing device loads the software instructions or script and executes them to perform the steps of the method(s).

In executing this software code, the system is able to perform any of the functionality of the method(s) described herein. It is important to note that the processing device is particularly important for functionality involving difficult calculations. This is important since difficult calculations are necessary in order to present feedback and demand information in a meaningful way. Such calculations include utilizing the feedback and demand information to determine what price point and what feature set a product should have in order to optimize revenue and/or profit for the one or more entities fulfilling the demand. In doing so, the one or more entities fulfilling the demand are provided with plots relating price point to revenue and (if cost data is entered) plots relating price point to profit.

The client's browser allows a user to access the functionality of the web application and the client's user interface allows the user to interact with it. It is to be understood that the user interface 1311 and the browser 1312 are rendered and executed by the client machine 1310 upon loading and executing software code or instructions which are tangibly stored on a computer readable medium, such as on a magnetic medium, e.g., a computer hard drive, an optical medium, e.g., an optical disc, solid-state memory, e.g., flash memory, and other storage media known in the art. Thus, any of the functionality performed by the browser 1312 and the web page 1313 described herein, such as the systems 100-900, is implemented in software code or instructions which are tangibly stored on a computer readable medium. Upon loading and executing such software code or instructions by the computer system 1310, the computer system 1310 may perform any of the functionality of the computer system 1310 described herein, including any steps of the systems 100-900 described herein. It is understood that the aforementioned relationships between 1310, 1311, 1312 and 1313 also apply between 1320, 1321, 1322 and 1323, as well as between 1330, 1331, 1332 and 1333.

The web applications also comprise software code or instructions which are tangibly stored on a server machine (1340), in a computer readable medium, such as on a magnetic hard drive, optical drive, solid-state memory, and other storage media known in the art (1343). Thus, any of the functionality performed by systems 100-900 described herein, such as hosting web applications, etc., is implemented in software code or instructions which are tangibly stored on a computer readable medium. Upon loading and executing such software code or instructions by the computer system 1340, the computer system 1340 may perform any of the functionality of systems 100-900 described herein.

As a whole, the computer network provides the means to reach a significant number of client machines and hence, a significant number of potential users. Having a significant number of users is important since the method described herein utilizes crowdsourcing and, as the name implies, crowdsourcing harnesses the power of a crowd. The larger the crowd, the greater the number of ideas, the greater the quantity of feedback, the greater the demand, the greater the funding, the greater the number of those with know-how for developing, sourcing, creating, executing, and/or delivering ideas, and ultimately the greater the number of successful fulfillment of ideas.

I claim:

1. A method for simplifying product idea development, the method comprising steps of:
receiving, by a server computer system from a first client computer system, via a web application running on the first client computer system, first data indicating a product idea;
receiving, by the server computer system from each of a plurality of second client computer systems, via the web application running on each of the plurality of second client computer systems, second data comprising one or more indications of demand for a product produced in accordance with the product idea, wherein the second data received from each of the plurality of second client computer systems comprises a promise to provide a monetary contribution in order to see the product idea come to fruition;
calculating, by the server computer system, demand metrics from the indications of demand of the second data received from each of the plurality of second client computer systems; and
transmitting, by the server computer system, the demand metrics to the first client computer system via the web application running on the first client computer system.

2. The method of claim 1,
wherein the product idea can be replaced with an idea for a service, policy change, or infrastructure change.

3. The method of claim 2,
wherein the second data further comprises feedback data for the product.

4. The method of claim 3,
wherein feedback data received by any of the plurality of second client computer systems is comprised of one or more of:
a maximum monetary contribution the user of the second client computer system would be willing to provide to see a completed product idea, wherein the completed product idea is the result of the product idea coming to fruition,
an indication of whether the user of the second client computer system would provide a monetary contribution of a different amount for the completed product idea depending upon whether the completed product idea had or did not have one or more different features,
an indication of whether the user of the second client computer system would only provide a monetary contribution for the completed product idea if one or more features specified by the user were to be present, and
an indication of whether the user of the second client computer system would only provide a monetary contribution for the completed product idea if one or more features specified by the user were not to be present.

5. The method of claim 4,
wherein the promise in the second data received by each of the plurality of second client computer systems is a conditional promise contingent upon the completed product idea being a compatible completed product, the compatible completed product comprising:
a completed product idea or an alternative version of the completed product idea which:
includes the one or more features specified by the user of the second client computer system to be present and
does not include the one or more features specified by the user of the second client computer system to not be present.

6. The method of claim 5,
wherein the demand metrics comprises one or more of:
the maximum revenue achievable based on the conditional promise received from each of the plurality of second client computer systems to provide a monetary contribution contingent upon the completed product idea being a compatible completed product
the optimal features to be included in a completed product idea to achieve the maximum revenue, and
the revenue which could be achieved for a completed product idea given the features to be included indicated in the third data.

7. The method of claim 5, further comprising steps of:
receiving, by the server computer system from the first client computer system, via the web application running on the first client computer system, third data indicating one or more of:
features to be included for a completed product idea,
features to be included for any alternative version of the completed product idea,
anticipated product cost information for a completed product idea, and
anticipated product cost information for any alternative version of the completed product idea,
so that demand metrics would comprise one or more of:
the maximum revenue achievable based on the conditional promise received from each of the plurality of second client computer systems to provide a monetary contribution contingent upon the completed product idea being a compatible completed product
the optimal features to be included in a completed product idea to achieve the maximum revenue,
the revenue which could be achieved for a completed product idea given the features to be included indicated in the third data,
the maximum profit achievable based on the conditional promise received from each of the plurality of second client computer systems to provide a monetary contribution contingent upon the completed product idea being a compatible completed product given the anticipated product cost information indicated in the third data,
the optimal features to be included in a completed product idea to achieve the maximum profit given the anticipated product cost information indicated in the third data, and
the profit which could be achieved for a completed product idea given the features to be included indicated in the third data and the anticipated product cost information indicated in the third data.

8. The method of claim 5,
wherein for each of the plurality of second client computer systems, the second data further comprises payment information such as bank information or credit card information so that the user of the second client computer system can be automatically charged, through a third party payment system or other method, an amount of money less than or equal to the maximum monetary contribution the user of the plurality of second client computer systems would be willing to provide should the user of the second client computer system be provided with a compatible completed product.

9. The method of claim 5,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and
demand metrics would comprise one or more of:
the maximum revenue achievable from what the users of the plurality of second client computer systems would pay to pre-order a completed product idea, the optimal features to be included in a completed product idea and the optimal price to be charged for the completed product idea to achieve the maximum revenue, and
a graph plotting the relationship between price to be charged for the completed product idea and achievable revenue.

10. The method of claim 5, further comprising steps of:
receiving, by the server computer system from the first client computer system, via the web application running on the first client computer system, third data indicating one or more of:
a price to be charged for a completed product idea,
a price to be charged for any alternative version of the completed product idea,
features to be included for a completed product idea,
features to be included for any alternative version of the completed product idea,
anticipated product cost information for a completed product idea, and
anticipated product cost information for any alternative version of the completed product idea,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and
demand metrics would comprise one or more of:
the maximum revenue achievable from what the users of the plurality of second client computer systems would pay to pre-order a completed product idea,
the optimal features to be included in a completed product idea and the optimal price to be charged for the completed product idea to achieve the maximum revenue,
the revenue which could be achieved for a completed product idea given the features to be included indicated in the third data and the price to be charged indicated in the third data,
a graph plotting the relationship between price to be charged for the completed product idea and achievable revenue,
the maximum profit achievable from what the users of the plurality of second client computer systems would pay to pre-order a completed product idea given the anticipated product cost information indicated in the third data,
the optimal features to be included in a completed product idea and the optimal price to be charged for the completed product idea to achieve the maximum profit given the anticipated product cost information indicated in the third data,
the profit which could be achieved for a completed product idea given the features to be included indicated in the third data, the price to be charged indicated in the third data, and the anticipated product cost information indicated in the third data, and
a graph plotting the relationship between price to be charged for the completed product idea and achievable profit given the anticipated product cost information indicated in the third data.

11. The method of claim 5, further comprising steps of:
transmitting, by the server computer system, the demand metrics to any of a plurality of third client computer systems via the web application running on each of the third client computer systems;
receiving, by the server computer system from any of the plurality of third client computer systems, via the web application running on each of the third client computer systems, fourth data comprising one or more proposals to provide the product for those who provided monetary contributions;
transmitting, by the server computer system, the proposals to provide the product to the first client computer system via the web application running on the first client computer system;
receiving, by the server computer system from the first client computer system, via the web application running on the first client computer system, fifth data comprising selection messages granting permission for selected users of third client computer systems have the right to a percentage of the monetary contributions and the right and requirement to provide the product for those who provided monetary contributions; and
transmitting, by the server computer system, the selection messages to third client computer systems via the web application running on the third client computer systems.

12. The method of claim 11,
wherein providing the product can include developing, sourcing, creating, executing, and/or delivering the product.

13. The method of claim 12,
wherein the fourth data comprises one or more of:
an estimated delivery date,
a price to be charged for a completed product idea,
an indication of which features will be included in the completed product idea,
a price to be charged for any alternative version of the completed product idea, and
an indication of which features will be included for any alternative version of the completed product idea.

14. The method of claim 12,
wherein the demand metrics comprises one or more of:
the maximum revenue achievable based on the conditional promise received from each of the plurality of second client computer systems to provide a monetary contribution contingent upon the completed product idea being a compatible completed product and
the optimal features to be included in a completed product idea to achieve the maximum revenue.

15. The method of claim 12, further comprising steps of:
receiving, by the server computer system from the first client computer system, via the web application running on the first client computer system, third data indicating one or more of:
features to be included for a completed product idea,
features to be included for any alternative version of the completed product idea,
anticipated product cost information for a completed product idea, and
anticipated product cost information for any alternative version of the completed product idea,
so that demand metrics would comprise one or more of:
the maximum revenue achievable based on the conditional promise received from each of the plurality of second client computer systems to provide a monetary contribution contingent upon the completed product idea being a compatible completed product
the optimal features to be included in a completed product idea to achieve the maximum revenue,
the revenue which could be achieved for a completed product idea given the features to be included indicated in the third data,
the maximum profit achievable based on the conditional promise received from each of the plurality of second client computer systems to provide a monetary contribution contingent upon the completed product idea being a compatible completed product given the anticipated product cost information indicated in the third data,
the optimal features to be included in a completed product idea to achieve the maximum profit given the anticipated product cost information indicated in the third data, and
the profit which could be achieved for a completed product idea given the features to be included indicated in the third data and the anticipated product cost information indicated in the third data.

16. The method of claim 13,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and
demand metrics would comprise one or more of:
the maximum revenue achievable from what the users of the plurality of second client computer systems would pay to pre-order a completed product idea,
the optimal features to be included in a completed product idea and the optimal price to be charged for the completed product idea to achieve the maximum revenue,
the revenue which could be achieved for a completed product idea given the features to be included indicated in the fourth data and the price to be charged indicated in the fourth data, and
a graph plotting the relationship between price to be charged for the completed product idea and achievable revenue,

17. The method of claim 13, further comprising steps of:
receiving, by the server computer system from any of the third client computer systems, via the web application running on the third client computer system, third data indicating one or more of:
a price to be charged for a completed product idea,
a price to be charged for any alternative version of the completed product idea,
features to be included for a completed product idea,
features to be included for any alternative version of the completed product idea,
anticipated product cost information for a completed product idea, and
anticipated product cost information for any alternative version of the completed product idea,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and
demand metrics would comprise one or more of:
the maximum revenue achievable from what the users of the plurality of second client computer systems would pay to pre-order a completed product idea,
the optimal features to be included in a completed product idea and the optimal price to be charged for the completed product idea to achieve the maximum revenue,
the revenue which could be achieved for a completed product idea given the features to be included indicated in the third data and the price to be charged indicated in the third data,
a graph plotting the relationship between price to be charged for the completed product idea and achievable revenue,
the maximum profit achievable from what the users of the plurality of second client computer systems would pay to pre-order a completed product idea given the anticipated product cost information indicated in the third data,
the optimal features to be included in a completed product idea and the optimal price to be charged for the completed product idea to achieve the maximum profit given the anticipated product cost information indicated in the third data,
the profit which could be achieved for a completed product idea given the features to be included indicated in the third data, the price to be charged indicated in the third data, and the anticipated product cost information indicated in the third data, and
a graph plotting the relationship between price to be charged for the completed product idea and achievable profit given the anticipated product cost information indicated in the third data.

18. A system for simplifying product idea development, the system comprising of:
a server computer system, a first client computer system, and a plurality of second client computer systems,
the first client computer system configured for:
receiving, via a web application running on the first client computer system, first data indicating a product idea and
transmitting, via the web application running on the first client computer system, the first data to the server computer system;
the plurality of second client computer systems configured for:
receiving, via the web application running on each of a plurality of second client computer systems, second data comprising one or more indications of demand for the product, wherein the second data received from each of the plurality of second client computer systems comprises a promise to provide a monetary contribution in order to see the product idea come to fruition and
transmitting, via the web application running on each of the plurality of second client computer systems, the second data to the server computer system; and
the server computer system configured for:
calculating demand metrics from the indications of demand of the second data received from each of the plurality of second client computer systems and
transmitting the demand metrics to the first client computer system via the web application running on the first client computer system.

19. The system of claim 18,
wherein the product idea can be replaced with an idea for a service, policy change, or infrastructure change.

20. The system of claim 19,
wherein the second data further comprises feedback data for the product.

21. The system of claim 20,
wherein feedback data received by any of the plurality of second client computer systems is comprised of one or more of:
a maximum monetary contribution the user of the second client computer system would be willing to provide to see a completed product idea, wherein the completed product idea is the result of the product idea coming to fruition,
an indication of whether the user of the second client computer system would provide a monetary contribution of a different amount for a completed product idea depending upon whether the completed product idea had or did not have one or more different features,
an indication of whether the user of the second client computer system would only provide a monetary contribution for the completed product idea if one or more features specified by the user were to be present, and
an indication of whether the user of the second client computer system would only provide a monetary contribution for the completed product idea if one or more features specified by the user were not to be present.

22. The system of claim 21,
wherein the promise in the second data received by each of the plurality of second client computer systems is a conditional promise contingent upon the completed product idea being a compatible completed product, the compatible completed product comprising:
a completed product idea or an alternative version of the completed product idea which:
includes the one or more features specified by the user of the second client computer system to be present and
does not include the one or more features specified by the user of the second client computer system to not be present.

23. The system of claim 22,
wherein the demand metrics comprises one or more of:
the maximum revenue achievable based on the conditional promise received from each of the plurality of second client computer systems to provide a monetary contribution contingent upon the completed product idea being a compatible completed product
the optimal features to be included in a completed product idea to achieve the maximum revenue, and
the revenue which could be achieved for a completed product idea given the features to be included indicated in the third data.

24. The system of claim 22,
wherein the first client computer system is further configured for:
receiving, via the web application running on the first client computer system,
third data indicating one or more of:
features to be included for a completed product idea,
features to be included for any alternative version of the completed product idea,
anticipated product cost information for a completed product idea, and anticipated product cost information for any alternative version of the completed product idea and
transmitting, via the web application running on the first client computer system, the third data to the server computer system,
so that demand metrics would comprise one or more of:
the maximum revenue achievable based on the conditional promise received from each of the plurality of second client computer systems to provide a monetary contribution contingent upon the completed product idea being a compatible completed product
the optimal features to be included in a completed product idea to achieve the maximum revenue,
the revenue which could be achieved for a completed product idea given the features to be included indicated in the third data,
the maximum profit achievable based on the conditional promise received from each of the plurality of second client computer systems to provide a monetary contribution contingent upon the completed product idea being a compatible completed product given the anticipated product cost information indicated in the third data,
the optimal features to be included in a completed product idea to achieve the maximum profit given the anticipated product cost information indicated in the third data, and
the profit which could be achieved for a completed product idea given the features to be included indicated in the third data and the anticipated product cost information indicated in the third data.

25. The system of claim 22,
wherein for each of the plurality of second client computer systems, the second data further comprises payment information such as bank information or credit card information so that the user of the second client computer system can be automatically charged, through a third party payment system or other method, an amount of money less than or equal to the maximum monetary contribution the user of the plurality of second client computer systems would be willing to provide should the user of the second client computer system be provided with a compatible completed product.

26. The system of claim 22,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and
demand metrics would comprise one or more of:
the maximum revenue achievable from what the users of the plurality of second client computer systems would pay to pre-order a completed product idea,
the optimal features to be included in a completed product idea and the optimal price to be charged for the completed product idea to achieve the maximum revenue, and
a graph plotting the relationship between price to be charged for the completed product idea and achievable revenue.

27. The system of claim 22,
wherein the first client computer system is further configured for:
receiving, via the web application running on the first client computer system, third data indicating one or more of:
a price to be charged for a completed product idea,
a price to be charged for any alternative version of the completed product idea,
features to be included for a completed product idea,
features to be included for any alternative version of the completed product idea,
anticipated product cost information for a completed product idea, and
anticipated product cost information for any alternative version of the completed product idea and
transmitting, via the web application running on the first client computer system, the third data to the server computer system,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and
demand metrics would comprise one or more of:
the maximum revenue achievable from what the users of the plurality of second client computer systems would pay to pre-order a completed product idea,
the optimal features to be included in a completed product idea and the optimal price to be charged for the completed product idea to achieve the maximum revenue,
the revenue which could be achieved for a completed product idea given the features to be included indicated in the third data and the price to be charged indicated in the third data,
a graph plotting the relationship between price to be charged for the completed product idea and achievable revenue,
the maximum profit achievable from what the users of the plurality of second client computer systems would pay to pre-order a completed product idea given the anticipated product cost information indicated in the third data,
the optimal features to be included in a completed product idea and the optimal price to be charged for the completed product idea to achieve the maximum profit given the anticipated product cost information indicated in the third data,
the profit which could be achieved for a completed product idea given the features to be included indicated in the third data, the price to be charged indicated in the third data, and the anticipated product cost information indicated in the third data, and
a graph plotting the relationship between price to be charged for the completed product idea and achievable profit given the anticipated product cost information indicated in the third data.

28. The system of claim 22,
the system further comprising of a plurality of third client computer systems,
wherein the first client computer system further configured for:
receiving, via the web application running on the first client computer system, fourth data comprising selection messages granting permission for selected users of third client computer systems to have the right to a percentage of the plurality of monetary contributions provided in order to see the product idea come to fruition and the right and requirement to provide a product produced in accordance with the product idea for those who provided the plurality of monetary contributions and
transmitting, via the web application running on the first client computer system, the fourth data to the server computer system;
the plurality of third client computer systems configured for:
receiving, via the web application running on any of the third client computer systems, fifth data comprising one or more proposals to provide the product for those who provided the plurality of monetary contributions and
transmitting, via the web application running on each of the third client computer systems from which the fifth data was received, the fifth data to the server computer system; and
the server computer system further configured for:
transmitting the demand metrics to any of the plurality of third client computer systems via the web application running on each of the third client computer systems;
transmitting any proposals received to the first client computer system via the web application running on the first client computer system; and
transmitting selection messages to third client computer systems via the web application running on the third client computer systems.

29. The system of claim 28,
wherein providing the product can include developing, sourcing, creating, executing, and/or delivering the product.

30. The system of claim 29,
wherein the fifth data comprises one or more of:
an estimated delivery date,
a price to be charged for a completed product idea,
an indication of which features will be included in the completed product idea,
a price to be charged for any alternative version of the completed product idea, and
an indication of which features will be included for any alternative version of the completed product idea.

31. The system of claim 29,
wherein the demand metrics comprises one or more of:
the maximum revenue achievable based on the conditional promise received from each of the plurality of second client computer systems to provide a monetary contribution contingent upon the completed product idea being a compatible completed product and
the optimal features to be included in a completed product idea to achieve the maximum revenue.

32. The system of claim 29,
wherein each of the plurality of third client computer systems are further configured for:
receiving, via the web application running on the third client computer system,
third data indicating one or more of:
features to be included for a completed product idea,
features to be included for any alternative version of the completed product idea,
anticipated product cost information for a completed product idea, and
anticipated product cost information for any alternative version of the completed product idea and
transmitting, via the web application running on the third client computer system, the third data to the server computer system,
so that demand metrics would comprise one or more of:
the maximum revenue achievable based on the conditional promise received from each of the plurality of second client computer systems to provide a monetary contribution contingent upon the completed product idea being a compatible completed product
the optimal features to be included in a completed product idea to achieve the maximum revenue,
the revenue which could be achieved for a completed product idea given the features to be included indicated in the third data,
the maximum profit achievable based on the conditional promise received from each of the plurality of second client computer systems to provide a monetary contribution contingent upon the completed product idea being a compatible completed product given the anticipated product cost information indicated in the third data,
the optimal features to be included in a completed product idea to achieve the maximum profit given the anticipated product cost information indicated in the third data, and
the profit which could be achieved for a completed product idea given the features to be included indicated in the third data and the anticipated product cost information indicated in the third data.

33. The system of claim 30,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and demand metrics would comprise one or more of:
the maximum revenue achievable from what the users of the plurality of second client computer systems would pay to pre-order a completed product idea,
the optimal features to be included in a completed product idea and the optimal price to be charged for the completed product idea to achieve the maximum revenue,
the revenue which could be achieved for a completed product idea given the features to be included indicated in the fifth data and the price to be charged indicated in the fifth data, and
a graph plotting the relationship between price to be charged for the completed product idea and achievable revenue,

34. The system of claim 30,
wherein each of the plurality of third client computer systems are further configured for:
receiving, via the web application running on the third client computer system, third data indicating one or more of:
a price to be charged for a completed product idea,
a price to be charged for any alternative version of the completed product idea,
features to be included for a completed product idea,
features to be included for any alternative version of the completed product idea,
anticipated product cost information for a completed product idea, and anticipated product cost information for any alternative version of the completed product idea and
transmitting, via the web application running on the third client computer system, the third data to the server computer system,
wherein the maximum monetary contribution a user of the each of the plurality of second client computer systems would be willing to provide is the maximum this user would pay to pre-order, and receive at a later date, a compatible completed product idea for himself, the compatible completed product further comprising:
a completed product idea or an alternative version of the completed product idea which:
has a price to be charged which is less than or equal to the maximum monetary contribution the user of the second client computer system would be willing to provide to see the product idea, with the features specified, come to fruition, so that
if the maximum the user would pay to pre-order is greater than the price to be charged for the compatible completed product, the user need only pay the price to be charged for that compatible completed product and not the maximum this user would pay and
demand metrics would comprise one or more of:
the maximum revenue achievable from what the users of the plurality of second client computer systems would pay to pre-order a completed product idea,
the optimal features to be included in a completed product idea and the optimal price to be charged for the completed product idea to achieve the maximum revenue,
the revenue which could be achieved for a completed product idea given the features to be included indicated in the third data and the price to be charged indicated in the third data,
a graph plotting the relationship between price to be charged for the completed product idea and achievable revenue,
the maximum profit achievable from what the users of the plurality of second client computer systems would pay to pre-order a completed product idea given the anticipated product cost information indicated in the third data,
the optimal features to be included in a completed product idea and the optimal price to be charged for the completed product idea to achieve the maximum profit given the anticipated product cost information indicated in the third data,
the profit which could be achieved for a completed product idea given the features to be included indicated in the third data, the price to be charged indicated in the third data, and the anticipated product cost information indicated in the third data, and
a graph plotting the relationship between price to be charged for the completed product idea and achievable profit given the anticipated product cost information indicated in the third data.
